(19) United States
(12) Patent Application Publication
(10) Pub. No.: US 2019/0266119 A1
(43) Pub. Date: Aug. 29, 2019

(54) EFFICIENT FAST LINK TURNAROUND PROCEDURE

(71) Applicant: QUALCOMM Incorporated, San Diego, CA (US)

(72) Inventor: George Alan WILEY, San Diego, CA (US)

(21) Appl. No.: 16/230,317

(22) Filed: Dec. 21, 2018

Related U.S. Application Data
(60) Provisional application No. 62/635,385, filed on Feb. 26, 2018.

(51) Int. Cl. G06F 13/40; G06F 13/20

(52) U.S. Cl. CPC G06F 13/4068; G06F 13/20

(57) ABSTRACT

System, methods and apparatus are described that support multimode operation of a data communication interface. A method performed in a device coupled to a multi-wire bus includes configuring a bus interface to drive the multi-wire bus in a high-speed mode, transmitting a plurality of symbols over the multi-wire bus while the bus interface is configured to drive the multi-wire bus in the high-speed mode, providing a control sequence of symbols in the plurality of symbols, and configuring the bus interface to operate as a receiver in the high-speed mode when the control code comprises a turnaround code. The first data may be encoded in the plurality of symbols. The control sequence of symbols may include a control code that is transmitted between two synchronizing sequences of symbols.

### PRIORITY CLAIM

This application claims priority to and the benefit of U.S. Provisional Patent Application Ser. No. 62/635,385 filed in the U.S. Patent Office on Feb. 26, 2018, the entire content of this application being incorporated herein by reference as if fully set forth below in its entirety and for all applicable purposes.

### TECHNICAL FIELD

At least one aspect generally relates to data communications interfaces, and more particularly, to data communications interfaces configurable for communicating in multiple modes and/or speeds between integrated circuit devices.

### BACKGROUND

Manufacturers of mobile devices, such as cellular phones, may obtain components of the mobile devices from various sources, including different manufacturers. For example, the application processor in a cellular phone may be obtained from a first manufacturer, while the display for the cellular phone may be obtained from a second manufacturer. Moreover, multiple standards are defined for interconnecting certain components of the mobile devices. For example, there are multiple types of interface defined for communications between an application processor and display and camera components of a mobile device. Some components employ an interface that conforms to one or more standards specified by the Mobile Industry Processor Interface (MIPI) Alliance. For example, the MIPI Alliance defines protocols for a camera serial interface (CSI) and a display serial interface (DSI).

MIPI CSI-2 and MIPI DSI or DSI-2 standards define a wired interface between a camera and application processor, or an application processor and display. The low-level physical-layer (PHY) interface in each of these applications can be provided in accordance with MIPI Alliance specifications for C-PHY interfaces. High-speed modes and low-power modes of communication are defined for C-PHY interfaces. The C-PHY high-speed mode uses a low-voltage multiphase signal transmitted in different phases on a 3-wire link. The low-power modes of C-PHY interfaces provide lower rates than the high-speed mode and transmits signals at higher voltages where the high-speed signals are undetectable by receivers configured for low-power operation.

As device technology improves, higher data rates and lower-power consumption may be obtained when devices are operated at lower voltage levels. There is a need to improve C-PHY interfaces to take advantage of technology improvements.

### SUMMARY

Embodiments disclosed herein provide systems, methods and apparatus that enable two or more Integrated Circuit (IC) devices to communicate bi-directionally using any of a plurality of interface standards, and in a high-speed mode and in a low-power mode. According to certain aspects described herein, two or more IC devices may be collocated in an electronic apparatus and communicatively coupled through one or more data links that can be configured with one of a plurality of interface standards.

In an aspect of the disclosure, a method performed in a device coupled to a multi-wire bus includes configuring a bus interface to drive the multi-wire bus in a high-speed mode, transmitting a plurality of symbols over the multi-wire bus while the bus interface is configured to drive the multi-wire bus in the high-speed mode, providing a control sequence of symbols in the plurality of symbols, and configuring the bus interface to operate as a receiver in the high-speed mode when the control code includes a turnaround code. The first data may be encoded in the plurality of symbols. The control sequence of symbols may include a control code that is transmitted between two synchronizing sequences of symbols.

In certain aspects, the method includes encoding 16 bits of the data in a permutation of 7 symbols, and transmitting the 7 symbols as part of the plurality of symbols. Each symbol may define signaling state of three wires in a corresponding symbol transmission interval. Timing information associated with transmission of the 7 symbols may be encoded in transitions of state of the three wires between each pair of consecutive symbol transmission intervals. The 16 bits of the data in the permutation of 7 symbols may be encoded by using the 16 bits of the data to select the permutation of 7 symbols based on a mapping of 16-bit data to 7-symbol sequences. The turnaround code may include a 7-symbol sequence unused by the mapping of 16-bit data to 7-symbol sequences. 6 signaling states may be defined for the three wires, where signaling state changes between each pair of consecutive symbol transmission intervals, and where one of 5 available signaling states of the three wires for each symbol transmission interval is selected based on value of a corresponding symbol.

In one aspect, the method includes decoding second data from symbols received from the multi-wire bus after transmitting the turnaround code, and configuring the bus interface to drive the multi-wire bus in the high-speed mode after a second instance of the turnaround code is detected in the symbols received from the multi-wire bus.

In some aspects, the method includes providing a sequence of signaling states on the multi-wire bus when the bus interface is configured to drive the multi-wire bus in a low-power mode. The sequence of signaling states may be configured to indicate a transition from low-power mode to high-speed mode. Voltage range of signaling states in the high-speed mode may be lower than voltage range of corresponding signaling states in the low-power mode. The high-speed mode may be a MIPI Alliance defined C-PHY high-speed mode. Each of the two synchronizing sequences of symbols includes a MIPI Alliance defined C-PHY Post sequence.

In an aspect of the disclosure, an apparatus has a bus interface coupled to a 3-wire link and a state machine. The state machine may be adapted to configure the bus interface to drive the multi-wire bus in a high-speed mode, cause the bus interface to transmit a plurality of symbols over the multi-wire bus while the bus interface is configured to drive the multi-wire bus in the high-speed mode, provide a control sequence of symbols in the plurality of symbols, and configure the bus interface to receive from the multi-wire bus in the high-speed mode when the control code is a turnaround code. First data may be encoded in the plurality of symbols. The control sequence of symbols may include a control code that is transmitted between two synchronizing sequences of symbols.

In an aspect of the disclosure, a computer-readable medium stores data and instructions, including computer-executable code. The code may cause a computer or computing circuit to configure a bus interface to drive the multi-wire bus in a high-speed mode, transmit a plurality of symbols over the multi-wire bus while the bus interface is configured to drive the multi-wire bus in the high-speed mode, provide a control sequence of symbols in the plurality of symbols, and configure the bus interface to receive from the multi-wire bus in the high-speed mode when the control code is a turnaround code. The control sequence of symbols may include a control code that is transmitted between two synchronizing sequences of symbols. First data may be encoded in the plurality of symbols.

In an aspect of the disclosure, an apparatus includes means for configuring a bus interface to drive the multi-wire bus in a high-speed mode, means for transmitting a plurality of symbols over the multi-wire bus while the bus interface is configured to drive the multi-wire bus in the high-speed mode, means for providing a control sequence of symbols in the plurality of symbols, and means for configuring the bus interface to receive from the multi-wire bus in the high-speed mode when the control code is a turnaround code. The first data may be encoded in the plurality of symbols. The control sequence of symbols may include a control code that is transmitted between two synchronizing sequences of symbols.

### BRIEF DESCRIPTION OF THE DRAWINGS

FIG. 1 depicts an apparatus employing a data link between integrated circuit (IC) devices that selectively operates according to one of plurality of available standards.

FIG. 2 illustrates a system architecture for an apparatus employing a data link between IC devices.

FIG. 3 illustrates an example of a 3-phase polarity data encoder of a C-PHY interface.

FIG. 4 illustrates signaling in an example of a C-PHY interface.

FIG. 5 illustrates certain aspects of a receiver in a C-PHY interface.

FIG. 6 is state diagram illustrating all possible signaling states and transitions in a 3-wire 3-phase interface that provides 5 available state transitions at each symbol interval in accordance with certain aspects disclosed herein.

FIG. 7 illustrates an example of a C-PHY interface adapted for symbol and/or symbol sequence insertion according to certain aspects disclosed herein.

FIG. 8 illustrates high-speed and low-power signaling in C-PHY interfaces.

FIG. 9 illustrates transitions between modes of communication and turnaround procedures in a C-PHY interface that may be adapted in accordance with certain aspects disclosed herein.

FIG. 10 illustrates a first example of fast bus turnaround in a C-PHY interface adapted in accordance with certain aspects disclosed herein.

FIG. 11 illustrates a second example of fast bus turnaround in a C-PHY interface adapted in accordance with certain aspects disclosed herein.

FIG. 12 illustrates additional examples of fast bus turnaround in a C-PHY interface adapted in accordance with certain aspects disclosed herein.

FIG. 13 illustrates a configuration of an apparatus showing signals provided between elements of C-PHY interfaces adapted in accordance with certain aspects disclosed herein.

FIG. 14 is a state diagram illustrating an example of lane operation in a C-PHY interface that includes high-speed and advanced low-power modes of operation according to certain aspects disclosed herein.

FIG. 15 illustrates an example of efficient turnaround signaling provided in accordance with certain aspects disclosed herein.

FIG. 16 illustrates an example of a state diagram that is adapted in accordance with certain aspects disclosed herein.

FIG. 17 is a diagram illustrating an example of an apparatus employing a processing circuit that may be adapted according to certain aspects disclosed herein.

FIG. 18 is a flow chart of a data transfer method operational on one of two devices in an apparatus.

FIG. 19 is a diagram illustrating an example of a hardware implementation for an apparatus employing a processing employing a processing circuit adapted according to certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

In some instances, well-known structures and components are shown in block diagram form in order to avoid obscuring such concepts.

Several aspects of data communication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include read-only memory (ROM) or random-access memory (RAM), electrically erasable programmable ROM (EEPROM), including ROM implemented using a compact disc (CD) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

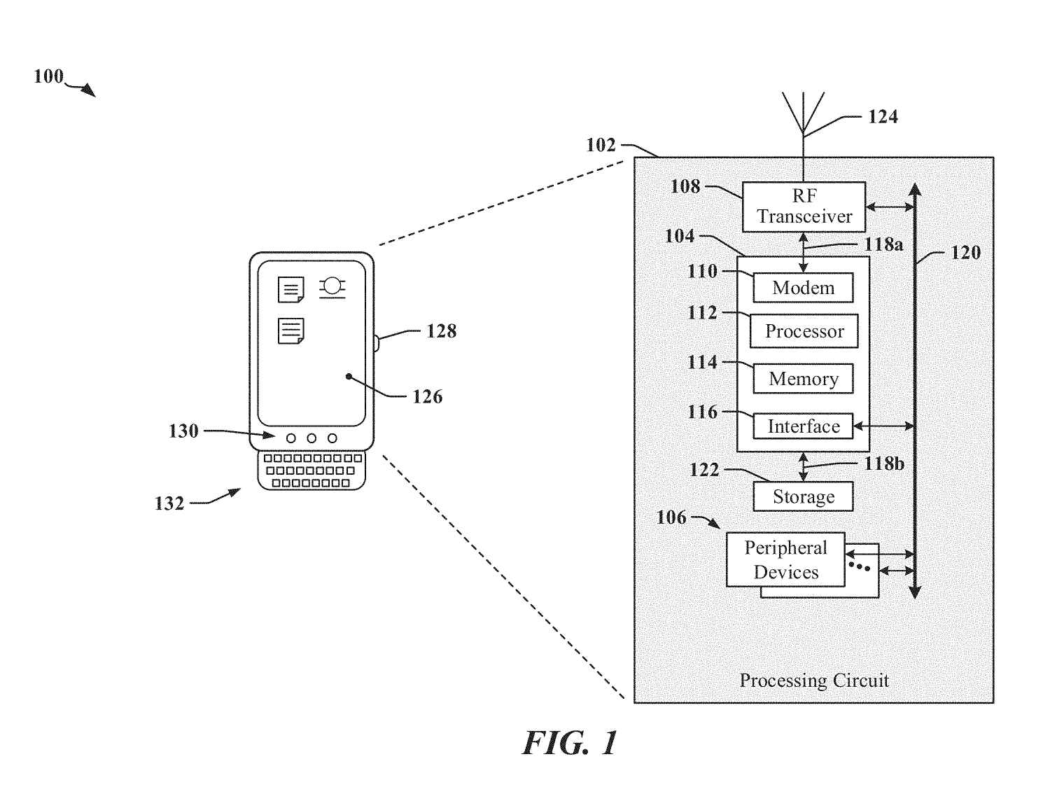

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

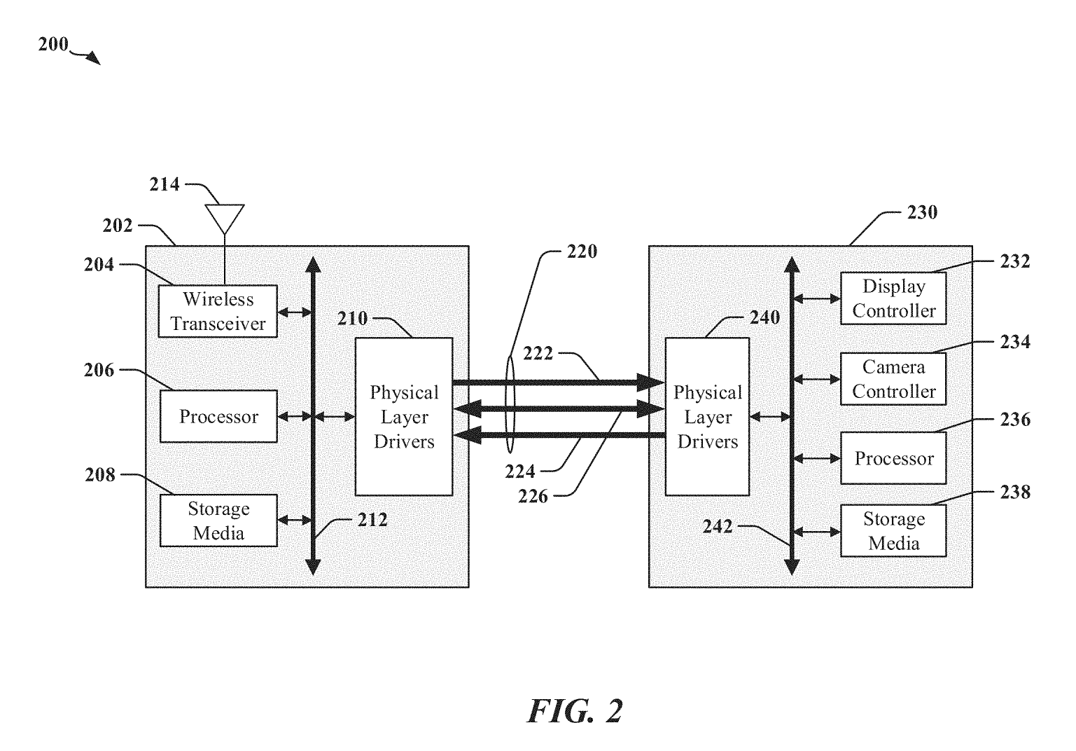

FIG. 2 illustrates certain aspects of an apparatus 200 that may be adapted in accordance with certain aspects disclosed herein. In one example, the apparatus 200 may be a mobile communication device implemented using one or more IC devices 202 and 230 that exchange data and control information through a communication link 220. The communication link 220 may be used to connect IC devices 202 and 230 that are located in close proximity to one another, or physically located in different parts of the apparatus 200. In one example, the communication link 220 may be provided on a chip carrier, substrate or circuit board that carries the IC devices 202 and 230. In another example, a first IC device 202 may be located in a keypad section of a mobile computing device while a second IC device 230 may be located in a display section of mobile computing device. In another example, a portion of the communication link 220 may include a cable or optical connection.

The communication link 220 may provide multiple channels 222, 224 and 226. One or more channels 226 may be bidirectional, and may operate in half-duplex and/or full-duplex modes. One or more channels 222 and 224 may be unidirectional. The communication link 220 may be asymmetrical, providing higher bandwidth in one direction. In one example described herein, a first channel may be referred to as a forward channel 222 while a second channel may be referred to as a reverse channel 224. The first IC device 202 may be designated as a host device or transmitter, while the second IC device 230 may be designated as a client device or receiver, even when both IC devices 202 and 230 are configured to transmit and receive on the forward channel 222. In one example, the forward channel 222 may operate at a higher data rate when communicating data from a first IC device 202 to a second IC device 230, while the reverse channel 224 may operate at a lower data rate when communicating data from the second IC device 230 to the first IC device 202.

The IC devices 202 and 230 may each have a processor or other processing and/or computing circuit or device 206, 236. In one example, the first IC device 202 may perform core functions of the apparatus 200, including maintaining communications through an RF transceiver 204 and an antenna 214, while the second IC device 230 may support a user interface that manages or operates a display controller 232. In another example, the second IC device 230 may be adapted to control operations of a camera or video input device using a camera controller 234. Other features supported by one or more of the IC devices 202 and 230 may include a keyboard, a voice-recognition component, and other input or output devices. The display controller 232 may include circuits and software drivers that support displays such as a liquid crystal display (LCD) panel, touch-screen display, indicators and so on. The storage media 208 and 238 may include transitory and/or non-transitory storage devices adapted to maintain instructions and data used by respective processors 206 and 236, and/or other components of the IC devices 202 and 230. Communication between each processor 206, 236 and its corresponding storage media 208 and 238 and other modules and circuits may be facilitated by one or more bus 212 and 242, respectively.

The reverse channel 224 may be operated in the same manner as the forward channel 222, and the forward channel 222 and reverse channel 224 may be capable of transmitting at comparable speeds or at different speeds, where speed may be expressed as data transfer rate and/or clocking rates. The forward and reverse data rates may be substantially the same or differ by orders of magnitude, depending on the application. In some applications, a single bidirectional channel 226 may support communications between the first IC device 202 and the second IC device 230. The forward channel 222 and/or reverse channel 224 may be configurable to operate in a bidirectional mode when, for example, the forward channel 222 and reverse channel 224 share the same physical connections and operate in a half-duplex manner. In one example, the communication link 220 may be operated to communicate control, command and other information between the first IC device 202 and the second IC device 230 in accordance with an industry or other standard.

In some instances, the forward channel 222 and/or reverse channel 224 may be configured or adapted to support a wide video graphics array (WVGA) 80 frames per second LCD driver IC without a frame buffer, delivering pixel data at 810 Mbps for display refresh. In another example, the forward channel 222 and/or reverse channel 224 may be configured or adapted to enable communications between with dynamic random access memory (DRAM), such as double data rate synchronous dynamic random access memory (SDRAM). The drivers 210, 240 may include encoding devices that can be configured to encode multiple bits per clock transition, and multiple sets of wires can be used to transmit and receive data from the SDRAM, control signals, address signals, and other signals.

The forward channel 222 and/or reverse channel 224 may comply with, or be compatible with application-specific industry standards. In one example, certain MIPI Alliance standards define physical layer interfaces between an application processor IC device 202 and an IC device 230 that supports the camera or display in a mobile device. The MIPI Alliance standards include specifications that govern the operational characteristics of products that can be considered to comply with MIPI Alliance specifications for mobile devices. In some instances, the MIPI Alliance standards may define interfaces that employ complimentary metal-oxide-semiconductor (CMOS) parallel busses.

The MIPI Alliance defines standards and specifications that may address communications affecting all aspects of operations in a mobile device, including the antenna, peripherals, the modem and application processors. For example, the MIPI Alliance defines protocols for a camera serial interface (CSI) and a display serial interface (DSI). The MIPI CSI-2 defines a wired interface between a camera and Application Processor and the MIPI DSI or DSI-2 defines a wired interface between an Application Processor and a display. The low-level physical layer (PHY) interface in each of these applications can be implemented in accordance with MIPI Alliance C-PHY specifications.

MIPI Alliance C-PHY Interface

According to certain aspects disclosed herein, systems and apparatus may employ multi-phase data encoding and decoding interface methods for communicating between IC devices 202 and 230. A multi-phase encoder may drive a plurality of conductors (i.e., M conductors). The M conductors typically include three or more conductors, and each conductor may be referred to as a wire, although the M conductors may include conductive traces on a circuit board or within a conductive layer of a semiconductor IC device. In one example, the MIPI Alliance-defined “C-PHY” physical layer interface technology may be used to connect camera and display devices 230 to an application processor device 202. The C-PHY interface employs three-phase symbol encoding to transmit data symbols on 3-wire lanes, or “trios” where each trio includes an embedded clock.

The M conductors may be divided into a plurality of transmission groups, each group encoding a portion of a block of data to be transmitted. An N-phase encoding scheme is defined in which bits of data are encoded in phase transitions and polarity changes on the M conductors. Decoding does not rely on independent conductors or pairs of conductors and timing information can be derived directly from phase and/or polarity transitions in the M conductors. N-Phase polarity data transfer can be applied to any physical signaling interface, including electrical, optical and radio frequency (RF) interfaces.

In the C-PHY example, a three-phase encoding scheme for a three-wire system may define a signal that can switch between three phase states and two polarities, providing 6 states and 5 possible transitions from each state. Deterministic voltage and/or current changes may be detected and decoded to extract data from the three wires.

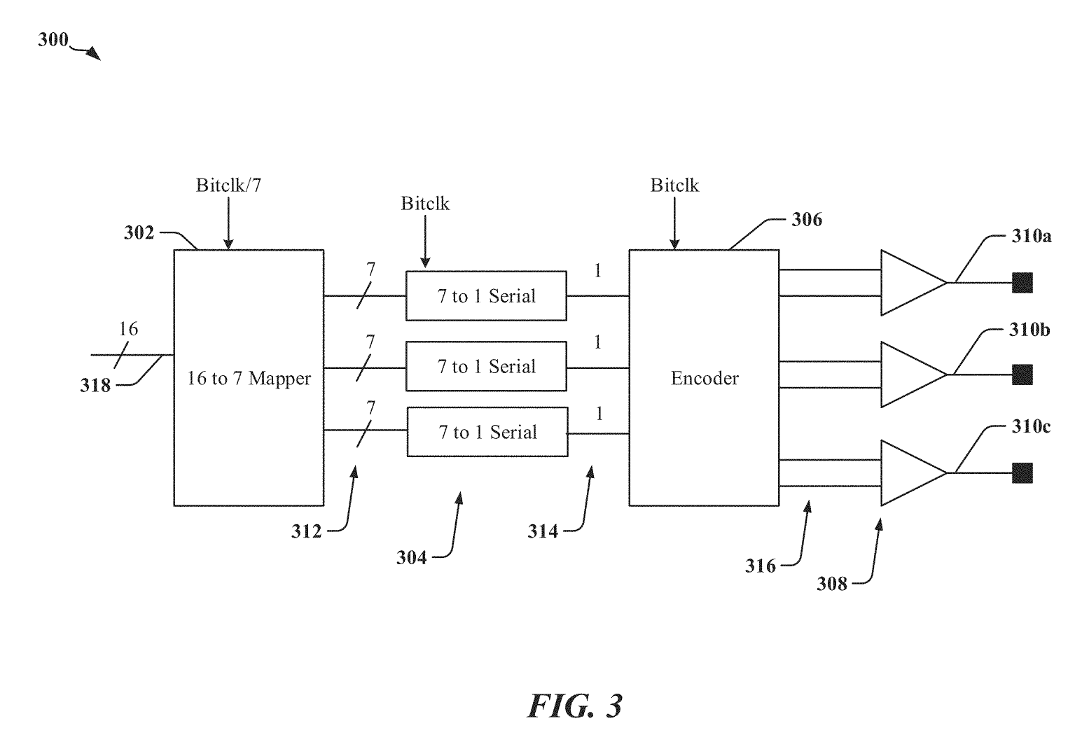

FIG. 3 illustrates an example of certain aspects of a C-PHY transmitter 300. The C-PHY transmitter 300 illustrates the use of N-phase polarity encoding to implement certain aspects of the communication link 220 depicted in FIG. 2. The C-PHY transmitter 300 may be coupled to three wires of a communication link 220, or one of the channels 222, 224, 226 of the communication link 220. The three wires may be part of a channel 222, 224, 226 that has more than three wires. The communication link 220 may include a wired bus having a plurality of signal wires, which may be configured to carry three-phase encoded data in a high-speed digital interface, such as a mobile display digital interface (MDDI). One or more of the channels 222, 224 and 226 may be configured or adapted to use three-phase polarity encoding. The physical layer drivers 210 and 240 may be adapted to encode and decode three-phase polarity encoded data transmitted using the C-PHY transmitter 300. The use of 3-phase polarity encoding provides for high-speed data transfer and may consume half or less of the power of other interfaces because fewer than 3 drivers in the C-PHY transmitter 300 are active at any time. The C-PHY transmitter 300 includes 3-phase polarity encoding circuits that may be provided in the physical layer drivers 210 and/or 240 and that can encode multiple bits per transition on the communication link 220. In one example, a combination of three-phase encoding and polarity encoding may be used to support a wide video graphics array (WVGA), 80 frames per second LCD driver IC without a frame buffer, delivering pixel data for display refresh at 810 Mbps over three or more wires.

The C-PHY transmitter 300 may be an M-wire, N-phase polarity encoding transmitter that is configured for M=3 and N=3. The example of three-wire, three-phase encoding C-PHY transmitter 300 is selected solely for the purpose of simplifying descriptions of certain aspects of this disclosure. The principles and techniques disclosed for three-wire, three-phase encoders can be applied in other configurations of M-wire, N-phase polarity encoders, and may comply or be compatible with other interface standards.

When three-phase polarity encoding is used, connectors such as signal wires 310a, 310b and 310c on a 3-wire bus may be undriven, driven positive, or driven negative. An undriven signal wire 310a, 310b or 310c may be in a high-impedance state. An undriven signal wire 310a, 310b or 310c may be driven or pulled to a voltage level that lies substantially halfway between the positive and negative voltage levels provided on driven signal wires. An undriven signal wire 310a, 310b or 310c may have no current flowing through it. In the example 300, each signal wire 310a, 310b and 310c may be in one of three states (denoted as +1, −1, or 0) using drivers 308. In one example, drivers 308 may include unit-level current-mode drivers. In another example, drivers 308 may drive opposite polarity voltages on two signals transmitted on the signal wires 310a and 310b while the third signal wire 310c is at high impedance and/or pulled to ground. For each transmitted symbol interval, at least one signal is in the undriven (0) state, while the number of signals driven positive (+1 state) is equal to the number of signals driven negative (−1 state), such that the sum of current flowing to the receiver is always zero. For each symbol, the state of at least one signal wire 310a, 310b or 310c is changed from the symbol transmitted in the preceding transmission interval.

The C-PHY transmitter 300 may have a mapper 302 that receives 16-bit input data 318 and maps the 16-bit input data 318 to 7 sequentially-transmitted symbols 312. Each symbol is used to define the signaling state of the signal wires 310a, 310b and 310c during its symbol transmission interval. An M-wire, N-phase encoder 306 configured for three-wire, three-phase encoding receives the 7 symbols 312 produced by the mapper one input symbol 314 at a time and computes the state of each signal wire 310a, 310b and 310c for each symbol transmission interval, based on the immediately preceding state of the signal wires 310a, 310b and 310c. The 7 symbols 312 may be serialized using parallel-to-serial converters 304, for example. The encoder 306 defines the signaling states of the signal wires 310a, 310b and 310c based on the input symbol 314 and the previous states of signaling signal wires 310a, 310b and 310c.

The use of M-wire, N-phase encoding permits a number of bits to be encoded in a plurality of symbols where the bits per symbol is not an integer. In the simple example of a three-wire, three-phase system, there are 3 available combinations of 2 wires, which may be driven simultaneously, and 2 possible combinations of polarity on any pair of wires that is driven simultaneously, yielding 6 possible states. Since each transition occurs from a current state, 5 of the 6 states are available at every transition. The state of at least one wire is typically required to change at each transition. With 5 states, log₂(5)≅2.32 bits may be encoded per symbol. Accordingly, a mapper may accept a 16-bit word and convert it to 7 symbols because 7 symbols carrying 2.32 bits per symbol can encode 16.24 bits. In other words, a combination of seven symbols that encodes five states has 5⁷ (78,125) permutations. Accordingly, the 7 symbols may be used to encode the 2¹⁶ (65,536) permutations of 16 bits.

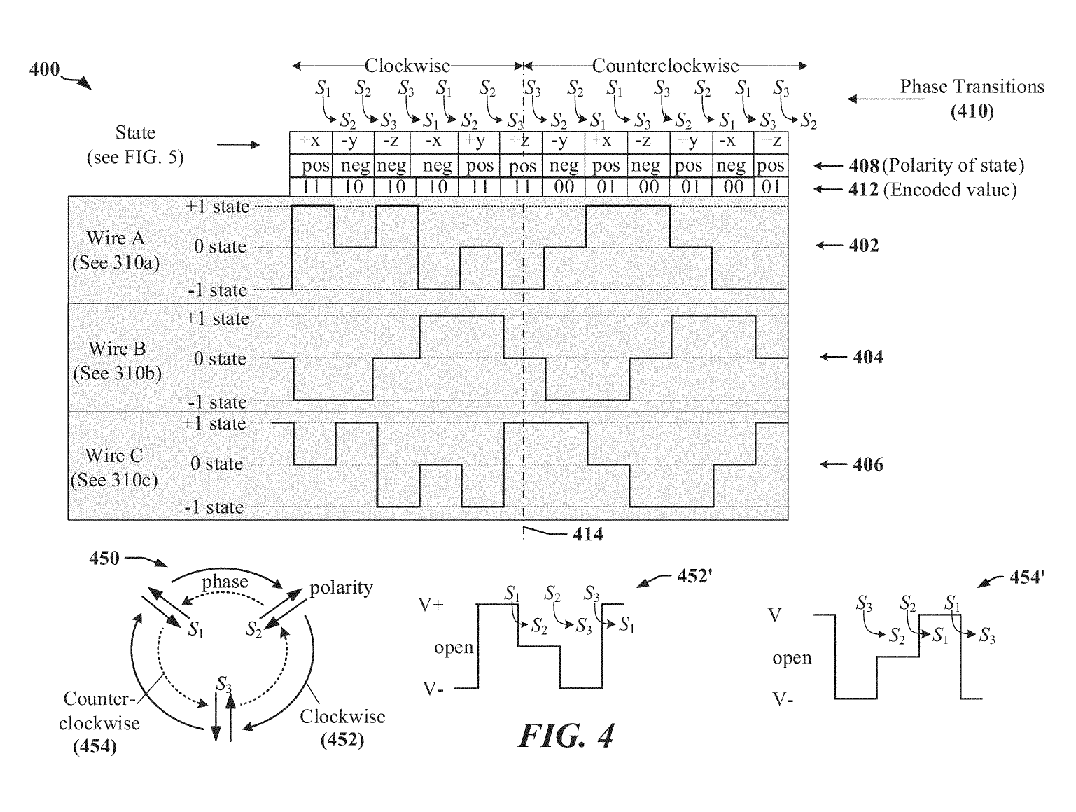

FIG. 4 illustrates an example of signaling 400 employing a three-phase modulation data-encoding scheme based on the circular state transition diagram 450. According to the data-encoding scheme, a three-phase signal may rotate in two directions and may be transmitted on three signal wires 310a, 310b and 310c. Each of the three signals is independently driven on the signal wires 310a, 310b, 310c. Each of the three signals includes the three-phase signal, with each signal being 120 degrees out of phase relative to the other two signals. At any point in time, each of the three signal wires 310a, 310b, 310c is in a different one of the states {+1, 0, −1}. At any point in time, each of the three signal wires 310a, 310b, 310c in a 3-wire system is in a different state than the other two wires. When more than three conductors or wires are used, two or more pairs of wires may be in the same state. The illustrated encoding scheme may also encode information in the polarity of the two signal wires 310a, 310b and/or 310c that are actively driven to the +1 and −1 states. Polarity is indicated at 408 for the sequence of states depicted.

At any phase state in the illustrated three-wire example, exactly two of the signal wires 310a, 310b, 310c carry a signal which is effectively a differential signal for that phase state, while the third signal wire 310a, 310b or 310c is undriven. The phase state for each signal wire 310a, 310b, 310c may be determined by voltage difference between the signal wire 310a, 310b or 310c and at least one other signal wire 310a, 310b and/or 310c, or by the direction of current flow, or lack of current flow, in the signal wire 310a, 310b or 310c. As shown in the state transition diagram 450, three phase states (S₁, S₂ and S₃) are defined. A signal may flow clockwise from phase state S₁ to phase state S₂, phase state S₂ to phase state S₃, and/or phase state S₃ to phase state S₁ and the signal may flow counter-clockwise from phase state S₁ to phase state S₃, phase state S₃ to phase state S₂, and/or phase state S₂ to phase state S₁. For other values of N, transitions between the N states may optionally be defined according to a corresponding state diagram to obtain circular rotation between state transitions.

In the example of a three-wire, three-phase communications link, clockwise rotations (S₁ to S₂), (S₂ to S₃), and/or (S₃ to S₁) at a state transition 410 may be used to encode a logic 1, while counter-clockwise rotations (S₁ to S₃), (S₃ to S₂), and/or (S₂ to S₁) at the state transition 410 may be used to encode a logic 0. Accordingly, a bit may be encoded at each transition by controlling whether the signal is “rotating” clockwise or counter-clockwise. For example, a logic 1 may be encoded when the three signal wires 310a, 310b, 310c transition from phase state S₁ to phase state S₂ and a logic 0 may be encoded when the three signal wires 310a, 310b, 310c transition from phase state S₁ to phase state S₃. In the simple three-wire example depicted, direction of rotation may be easily determined based on which of the three signal wires 310a, 310b, 310c is undriven before and after the transition.

Information may also be encoded in the polarity and/or changes of polarity of state 408 of the driven signal wires 310a, 310b, 310c, or in the direction of current flow or changes in the direction of current flow between two signal wires 310a, 310b, 310c. Signals 402, 404, and 406 illustrate voltage levels applied to signal wires 310a, 310b, 310c, respectively at each phase state in a three-wire, three-phase link Δt any time, a first signal wire 310a, 310b, 310c is coupled to a more positive voltage (+V, for example), a second signal wire 310a, 310b, 310c is coupled to a more negative voltage (−V, for example), while the third signal wire 310a, 310b, 310c may be open-circuited. As such, one polarity encoding state may be determined by the current flow between the first and second signal wires 310a, 310b, 310c or the voltage polarities of the first and second signal wires 310a, 310b, 310c. In some embodiments, two bits of data 412 may be encoded in each state transition 410. A decoder may determine the direction of signal phase rotation to obtain the first bit. The second bit may be determined based on the polarity difference between two of the signals 402, 404 and 406. In some instances, the second bit may be determined based on a change or lack of change in polarity of the differential signal transmitted on a pair of the signal wires 310a, 310b, 310c. The decoder having determined direction of rotation can determine the phase state and the polarity of the voltage applied between the two active signal wires 310a, 310b and/or 310c, or the direction of current flow through the two active signal wires 310a, 310b and/or 310c.

In the example of the three-wire, three-phase link described herein, one bit of data may be encoded in the rotation, or phase change in the three-wire, three-phase link, and an additional bit may be encoded in the polarity or changes in polarity of two driven wires. Certain embodiments, encode more than two bits in each transition of a three-wire, three-phase encoding system by allowing transition to any of the possible states from a current state. Given three rotational phases and two polarities for each phase, 6 states are defined, such that 5 states are available from any current state. Accordingly, there may be log₂(5)≅2.32 bits per symbol (transition) and the mapper may accept a 16-bit word and convert it to 7 symbols. In other words, a three-wire, three-phase C-PHY link may map 16 bits of input data 318 to the 7 symbols 312.

In other examples, an encoder may transmit symbols using 6 wires with two pairs of wires driven for each state. The 6 wires may be labeled A through F, such that in one state, wires A and F are driven positive, wires B and E negative, and C and D are undriven (or carry no current). For six wires, there may be:

$$C ( 6 , 4 ) = \frac{6 !}{( 6 - 4 ) ! \cdot 4 !} = 15$$

possible combinations of actively driven wires, with:

$$C ( 4 , 2 ) = \frac{4 !}{( 4 - 2 ) ! \cdot 2 !} = 6$$

different combinations of polarity for each phase state.

The 15 different combinations of actively driven wires may include:

| | | | | |
|---|---|---|---|---|
| A B C D | A B C E | A B C F | A B D E | A B D F |
| A B E F | A C D E | A C D F | A C E F | A D E F |
| B C D E | B C D F | B C E F | B D E F | C D E F |

Of the 4 wires driven, the possible combinations of two wires driven positive (and the other two must be negative). The combinations of polarity may include:

++−− +−−+ +−+− −+−+ −++− −−++

Accordingly, the total number of different states may be calculated as 15×6=90. To guarantee a transition between symbols, 89 states are available from any current state, and the number of bits that may be encoded in each symbol may be calculated as: log₂(89)≅6.47 bits per symbol. In this example, a 32-bit word can be encoded by the mapper into 5 symbols, given that 5×6.47=32.35 bits.

The general equation for the number of combinations of wires that can be driven for a bus of any size, as a function of the number of wires in the bus and number of wires simultaneously driven:

$$C ( {N}_{wires} , {N}_{driven} ) = \frac{{N}_{wires} !}{( {N}_{wires} - {N}_{driven} ) ! \cdot {N}_{driven} !}$$

The equation for the number of combinations of polarity for the wires being driven is:

$$C ( {N}_{driven} , \frac{{N}_{driven}}{2} ) = \frac{{N}_{driven} !}{{( ( \frac{{N}_{driven}}{2} ) ! )}^{2}}$$

The number of bits per symbol is:

$${log}_{2} ( C ( {N}_{wires} , {N}_{driven} ) \cdot C ( {N}_{driven} , \frac{{N}_{driven}}{2} ) - 1 ) .$$

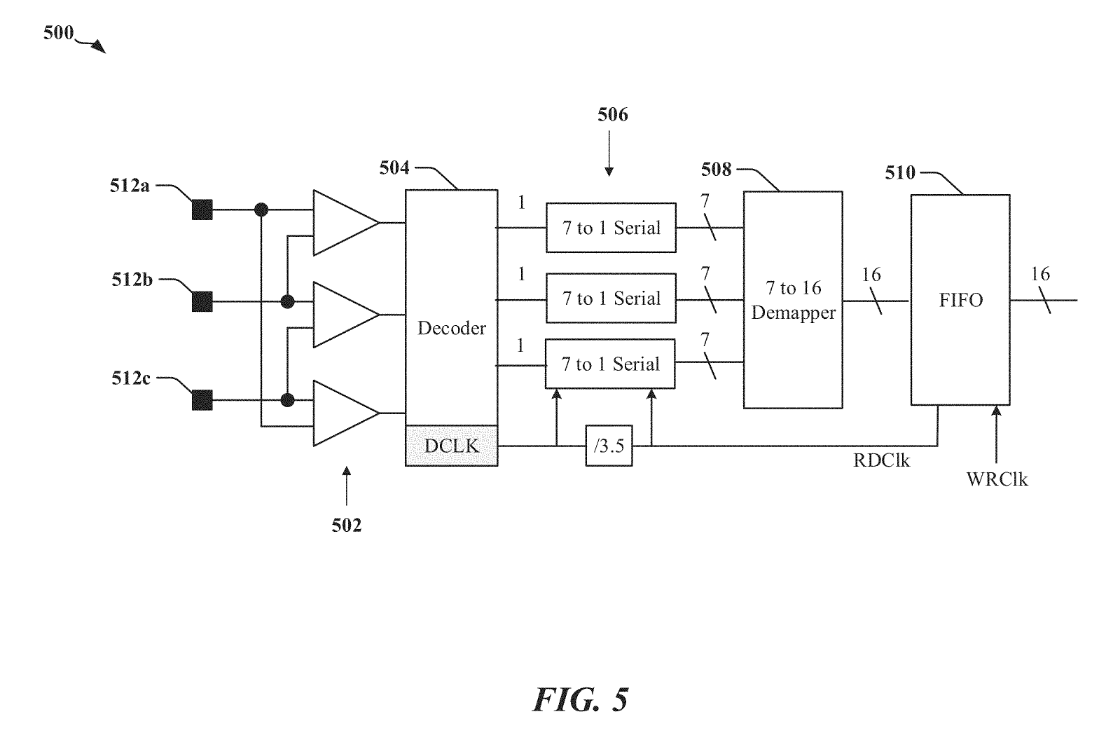

FIG. 5 illustrates an example of a receiver 500 in a three-wire, three-phase PHY. The three-wire, three-phase example is illustrative of certain principles of operation applicable to other configurations of M-wire, N-phase receivers. Comparators 502 and decoder 504 are configured to provide a digital representation of the state of each of three transmission lines 512a, 512b and 512c, as well as the change in the state of the three transmission lines compared to the state transmitted in the previous symbol period. Seven consecutive states are assembled by serial-to-parallel convertors 506 to produce a set of 7 symbols to be processed by a demapper 508 to obtain 16 bits of data that may be buffered in a first-in-first-out (FIFO) storage device 510, which may be implemented using registers, for example.

According to certain aspects disclosed herein, a plurality of three-state amplifiers can be controlled to produce a set of output states defined by a differential encoder, an N-phase polarity encoder, or another encoder that encodes information in wires or connectors that can assume one of the three states described.

With reference again to FIGS. 2 and 3, the communication link 220 may include a high-speed digital interface that can be configured to support both differential encoding scheme and N-phase polarity encoding. Physical layer drivers 210 and 240 may include N-phase polarity encoders and decoders, which can encode multiple bits per transition on the interface, and line drivers to drive signal wires 310a, 310b and 310c. The line drivers may be constructed with amplifiers that produce an active output that can have a positive or negative voltage, or a high impedance output whereby a signal wires 310a, 310b or 310c is in an undefined state or a state that is defined by external electrical components. Accordingly, the output drivers 308 may receive by a pair of signals 316 that includes data and output control (high-impedance mode control). In this regard, the three-state amplifiers used for N-phase polarity encoding and differential encoding can produce the same or similar three output states.

### Encoding in a MIPI Alliance C-PHY Interface

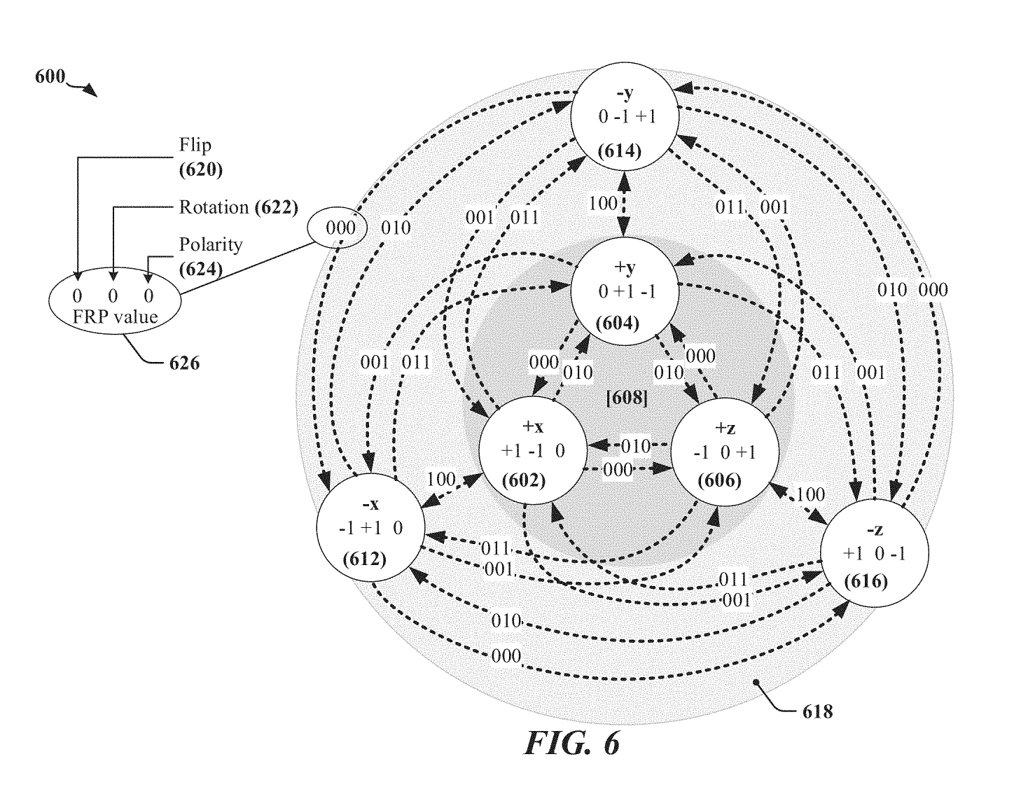

FIG. 6 is a state transition diagram 600 illustrating the possible signaling states 602, 604, 606, 612, 614, 616 of the three wires in a 3-wire, 3-phase interface, including in a MIPI Alliance C-PHY high-speed mode interface for example. All possible transitions from each state 602, 604, 606, 612, 614, 616 are illustrated. The transitions in the state transition diagram 600 can be represented by a Flip, Rotate, Polarity (FRP) symbol 626 that has one of the three-bit binary values in the set: {000, 001, 010, 011, 100}. The Rotation bit 622 of the FRP symbol 626 indicates the direction of phase rotation associated with a transition to a next state. The Polarity bit 624 of the FRP symbol 626 is set to binary 1 when a transition to a next state involves a change in polarity. When the Flip bit 620 of the FRP symbol 626 is set to binary 1, the Rotate and Polarity values may be ignored and/or zeroed. A flip represents a state transition that involves only a change in polarity. Accordingly, the phase of a 3-phase signal is not considered to be rotating when a flip occurs and the polarity bit is redundant when a flip occurs. The FRP symbol 626 corresponds to wire state changes for each transition. The state transition diagram 600 may be separated into an inner circle 608 that includes the positive polarity states 602, 604, 606 and an outer circle 618 that encompasses the negative polarity states 612, 614, 616.

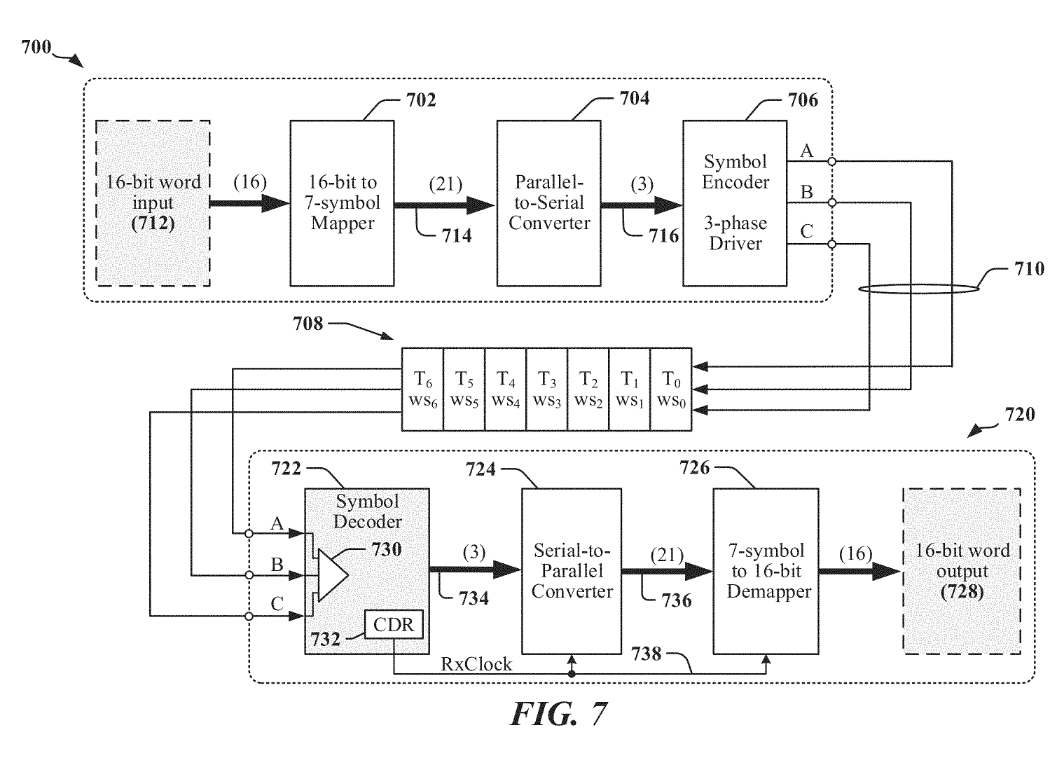

FIG. 7 illustrates a transmitter 700 and a receiver 720 configured for a 3-wire, 3-phase interface that may use the FRP symbol 626 to select a next symbol for transmission based on the immediately preceding symbol. A 16-bit data word 712 is received as an input to a Mapper 702 in the transmitter 700. The Mapper 702 maps the 16-bit data to a 21-bit word 714 representative of 7 FRP symbols. The 21-bit word 714 is converted to a sequence of 3-bit symbols 716 using a Parallel-To-Serial converter 704. Each symbol in the sequence of 3-bit symbols 716 may be provided to a Symbol Encoder/Driver 706 configured to produce a sequence of signaling states 708 on a 3-wire data link 710.

At the receiver 720, a Receiver/Symbol Decoder 722 decodes the sequence of signaling states 708, which are received from the 3-wire data link 710 using comparison circuits 730. In certain implementations, the comparison circuits 730 in the Receiver/Symbol Decoder 722 may be implemented as a set of differential receivers that produces an output used to provide the sequence of FRP symbols 734. The Receiver/Symbol Decoder 722 may include a clock and data recovery (CDR) circuit 732 that generates a clock signal 738 by extracting timing information from changes in signaling state corresponding to transitions between symbols in the sequence of signaling states 708. The Receiver/Symbol Decoder 722 produces a sequence of FRP symbols 734 that is provided to a Serial-to-Parallel Converter 724, which in turn provides a 21-bit word 736 to a Demapper 726. The 16-bit output 728 of the Demapper 726 corresponds to the 16-bit data word 712 input of the transmitter 700.

The transmitter 700 and receiver 720 may be operated to obtain an optimal encoding of 16-bit data, by mapping 16-bit words to 7-symbol sequences, where symbols maximize the number of signaling states 602, 604, 606, 612, 614, 616 of the three wires in a 3-wire, 3-phase interface available for encoding purposes at each symbol transition. In the example illustrated in FIG. 6, six signaling states 602, 604, 606, 612, 614, 616 are defined, with 5 possible transitions from each of the signaling states 602, 604, 606, 612, 614, 616. In a C-PHY interface, the mapper 604 maps 65,536 possible values of 16-bit data words 712 to 65,536 of the 78,125 possible permutations of 7-symbols corresponding to sequences of phase and polarity for the three wires, leaving up to 12,589 sequences of symbols that may be unused by the mapper 702.

### Low-Voltage, Lower-Power Mode in C-PHY Interfaces

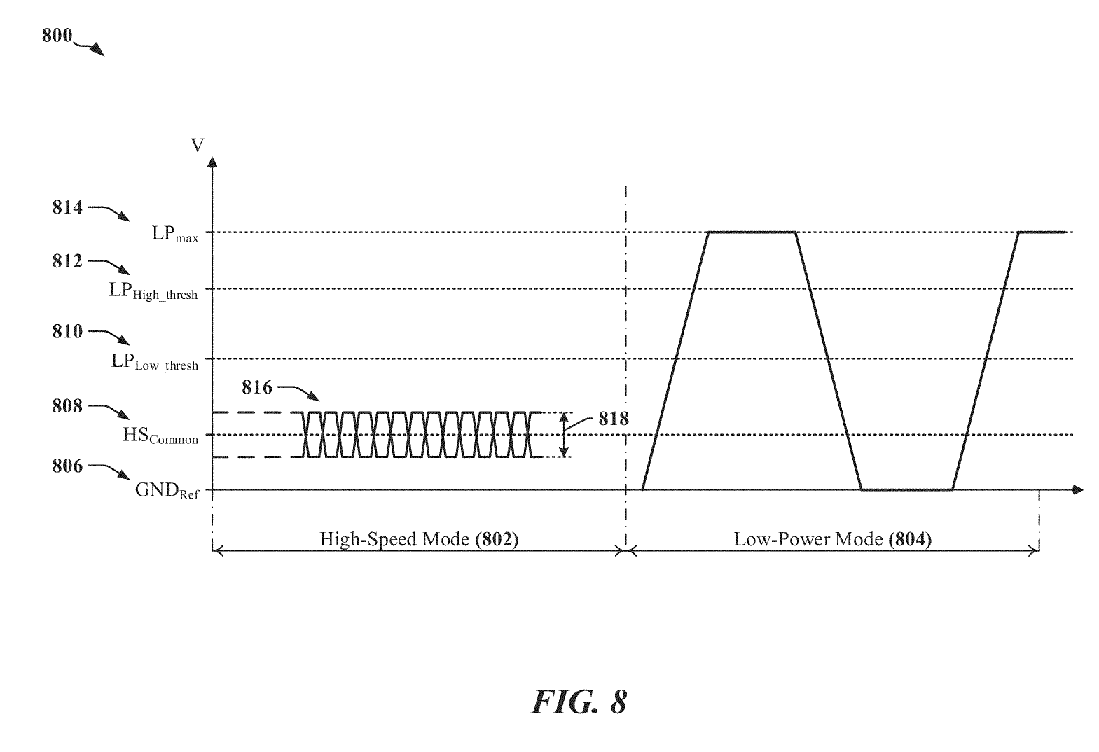

FIG. 8 graphically represents examples of waveforms 800 that illustrate certain aspects of signaling in C-PHY interfaces that support a high-speed communication mode 802 and a low-power communication mode 804. Data is transmitted at a significantly lower rate in the low-power communication mode 804 than in the high-speed communication mode 802. The high-speed communication mode 802 and the low-power communication mode 804 operate at different voltage levels and voltage ranges when transmitting signal using the same wires of a serial bus.

In the high-speed communication mode 802, signals are centered on a high-speed common (HS_{Common}) voltage level 808, which is offset from a reference ground voltage level 806. Signals in the high-speed communication mode 802 have a voltage range 818 that ensures that high-speed signals 816 do not exceed a logic low threshold voltage level (LP_{Low_thresh}) 810, which defines the upper limit for logic low in the low-power communication mode 804. In one C-PHY example, the HS_{common} voltage level 808 may be nominally defined to be 250 millivolts (mV), and the voltage range 818 for high-speed signals may be nominally defined to be 250 mV.

In the low-power communication mode 804, signals switch between a maximum low-power (LPₘₐₓ) voltage level 814 and the reference ground voltage level 806. The logic low voltage levels LP_{Low_thresh} 810 and the logic high threshold voltage level (LP_{High_thresh}) 812 define the switching voltage levels for high-to-low transitions and low-to high transitions, respectively. In one example, the maximum low-power (LPₘₐₓ) voltage level 814 may be nominally defined at 1.2 Volts (V).

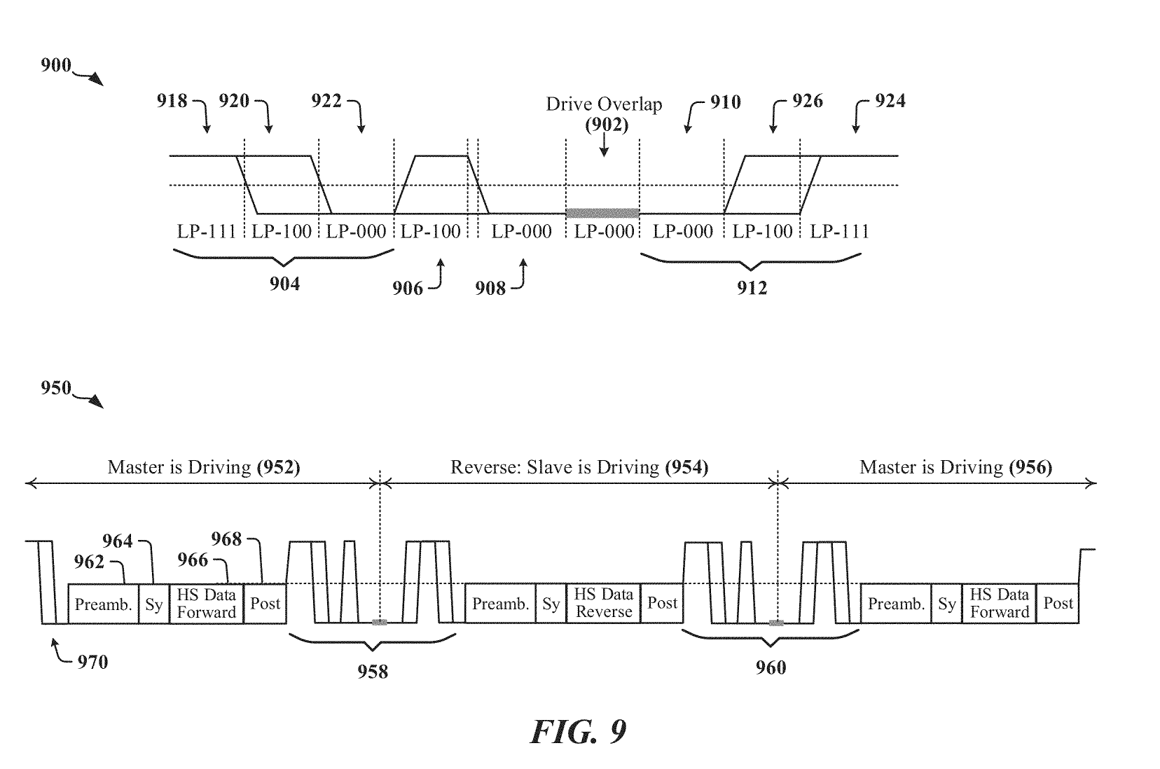

With reference to FIG. 9, transitions between modes of communication in a conventional C-PHY interface are effected using low-power mode signaling. Transitions between modes may be initiated by transmission of one or more codes that produce certain signaling states defined by C-PHY protocols. In an example illustrated in the first timing diagram 900, a transition from low-power mode to high-speed mode is indicated by transmission of sequence of codes that produces a corresponding sequence of signaling states using the voltage levels defined for low-power modes of communication.

In an example where a high-speed reverse communication is desired, conventional C-PHY devices use low-power mode signaling to effect a turnaround of data transmission direction. Turnaround may be used to provide communication opportunities for slave devices at high-speed data rates when the C-PHY interface provides a bidirectional lane between a master device and a slave device. The transmission direction of a bidirectional lane can be changed using a procedure defined by conventional C-PHY protocols. The procedure toggles direction of data flow over the C-PHY link, such that the same procedure is executed to change data flow from a master to slave (forward direction) to data flow from the slave to the master (reverse direction) and to change data flow from the reverse direction to the forward direction.

The first timing diagram 900 illustrates execution of a change of transmission direction from a forward direction to a reverse direction. The procedure is initiated when the master device transmits a sequence 904 including a first Stop state using LP-111 918, a first Low-Power Request state using LP-100 920 and a Bridge state using LP-000 922. The master device then transmits a second LP-100 906 followed by a second LP-000 908. The master device asserts the second LP-000 908 for a predefined minimum period of time before releasing the interface. The master device releases the interface when it ceases to drive the three wires of the interface.

The slave device waits for a period of time after the commencement of the second LP-000 908 before driving the wires in a third Bridge state using LP-000 910. For some period of time, an overlap (LP-000 902) occurs when both the master device and slave device may be driving the wires of the interface. The slave device then provides LP-100 926. The master device may identify the slave-provided LP-100 926 as an acknowledgement that the slave device has taken control of the interface. The slave device drives a Stop state using LP-111 924 to confirm completion of bus turnaround.

The second diagram 950 illustrates a sequence of high-speed transmissions 952, 954, 956 that involves two turnaround procedures 958, 960. The first high-speed transmission 952 is a forward transmission from a master device to a slave device, the second high-speed transmission 954 is a reverse transmission from the slave device to the master device, and the third high-speed transmission 956 is a forward transmission from the master device to the slave device. In the first high-speed transmission 952, for example, the transmitting device (here the master device) transmits a sequence 970 of low-power states to cause the C-PHY interface to enter high-speed communication mode. The transmitting device then transmits a high-speed preamble 962 and synchronization symbols 964, which cause the receiving device to generate a receive clock and attain synchronization prior to transmission of the high-speed data 966. A Post sequence 968 is transmitted to indicate that end of the transmission. The transmitting device then exits high-speed mode to perform the turnaround procedure 958 or 960 that results in link turnaround and reentry to high-speed mode. Each of the turnaround procedures 958 or 960 includes transmission of the same sequence of low-power signaling states.

In a C-PHY interface, the high-speed preamble 962 and Post sequence 968 are provided by the transmitter for receiver synchronization purposes. The high-speed preamble 962 and Post sequence 968 extend high-speed data bursts at the transmitter and may enable the receiver to ignore ambiguous operating states. In one example, the Post sequence 968 includes a unique sequence of seven symbols that have the value “4” transmitted to indicate an end of Packet Data to the receiver. The Post sequence 968 may include multiple seven-symbol sequences to enable a receiver to generate sufficient clock pulses to receive, decode and clear any pipelined decoded data in the receiver interface. The number of seven-symbol sequences in the Post sequence 968 may be defined by a programmable value configured in the transmitter.

The use of low-power signaling to perform turnaround procedures can result in decreased performance of a C-PHY interface. Each of the signaling states used in the turnaround procedures is asserted for predefined minimum periods of times that permit the transitioning of signals within the low-power voltage ranges. The duration of the turnaround procedure can decrease the overall data rate of the C-PHY interface significantly.

### Symbol-Based Mode Control in a C-PHY Interface

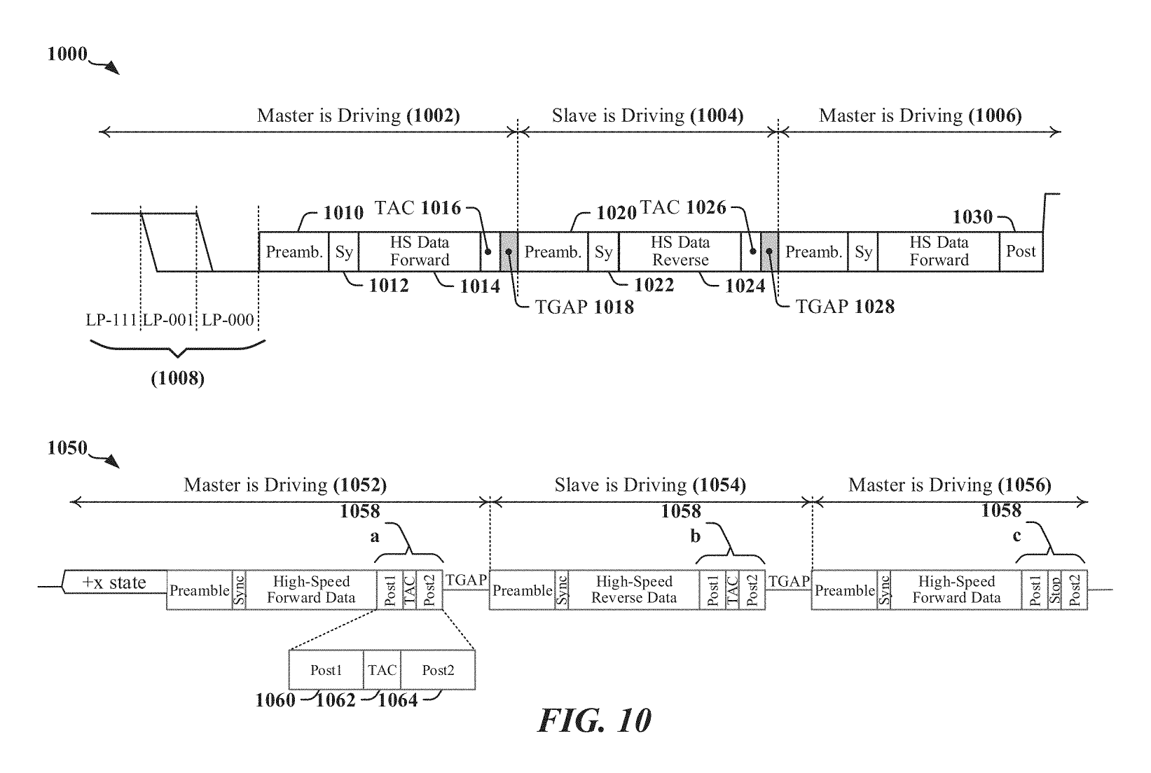

Certain aspects disclosed herein, relate to a turnaround procedure for C-PHY interfaces mode that can be performed without entering a low-power mode of communication when the C-PHY interfaces are operating in high-speed mode. In some instances, each turnaround time can be reduced by approximately 1 microsecond. FIG. 10 illustrates one example, in which turnaround may be accomplished in high-speed mode by transmitting unused (unmapped) symbol sequences in the high-speed data to signal a turn-around event. As disclosed herein, a C-PHY interface using three signal wires may transmit a 16-bit word in a sequence of seven 3-Phase symbols such that clock information is embedded by causing at least one of the three signal wires to experience a change in signaling state between each pair of consecutively transmitted symbols. As illustrated in FIG. 7, a transmitter 700 may use a mapper 702 to select a sequence of seven symbols in the 21-bit word 714 714 in a protocol layer above the symbol encoding. The 21-bit word 714 that carries the sequence of seven symbols is serialized and used by a symbol encoder 706 to determine a signaling state of a trio (the 3-wire link 710) based on the signaling state produced from the previous symbol. In each symbol time epoch, the signals on the three-wire trio can transition to one of five other states. In a group of seven consecutive symbols there are 5⁷=78,125 possible permutations, with only 2¹⁶=65,536 permutations needed to encode 16 binary bits of information, leaving 12,589 permutations of seven symbols that are not used by the mapper 702. Some of the permutations (seven-symbol sequences) may be assigned for special purposes such as the Sync Word 1012 and the Post sequence 1030, which the PHY can be configured to detect during normal reception of high-speed data. The Preamble 1010 includes a continuous steam of symbols having the same value that is transmitted prior to the first occurrence of the Sync Word 1012. The Preamble 1010 does not need to be assigned an unmapped permutation code, and the interpretation of the Preamble 1010 can be based on a burst reception state. Some of the unused seven-symbol sequences can be used for other purposes such as run-length control. Even with these other uses of unmapped seven-symbol sequences, there remain unused sequences available for purposes that include turnaround signaling.

According to certain aspects, an unused sequence may be assigned as a Turnaround Code (TAC) 1016, 1026. The TAC 1016, 1026 is transmitted to signal the receiver to stop reception and to indicate that a change in the direction of transmission is to occur. As illustrated in the first timing diagram 1000 of FIG. 10, a high-speed burst begins after transmission of a Start of Transmission (SoT) sequence 1008 that may include LP codes {LP-111, LP-001, LP-000} as described in relation to FIG. 9. In high-speed communication mode, transmission begins with a Preamble 1010 and a Sync Word 1012, followed by the High-Speed Forward Data 1014. At the end of the High-Speed Forward Data 1014 the master device sends a TAC 1016 to signal a change in direction. The master device then commences a turnaround gap (TGAP) 1018 by driving the physical interface to a fixed state, and then begins to disable its High-Speed drivers. In one example, the interface is in the +x state (see FIGS. 4 and 6) during the TGAP 1018. The slave device begins driving the same +x state on the physical interface during TGAP 1018. After a delay, the slave device begins to transmit the Preamble 1020 followed by the Sync pattern 1022 to synchronize the receiver in the master device. After the slave device has transmitted the Sync pattern 1022, it may send High-Speed Reverse Data 1024 to the master device. At the end of the High-Speed Reverse Data 1024 the slave device sends a TAC 1026 to signal a change in direction. The slave device then commences a TGAP 1028 by driving the physical interface to a fixed state, and then begins to disable its High-Speed drivers. The change from reverse direction to forward direction is then completed when the master device drives the interface during the TGAP 1028.

The TAC 1016, 1026 provides a robust method of indicating change of direction and the TAC 1016, 1026 may operate, in certain respects, like the Post sequence 1030. Whereas the Post sequence 1030 is used to indicate the end of a high-speed transmission and a return to the low-power communication mode, the TAC 1016, 1026 provides a receiver with an indication of the end of high-speed transmission in one direction prior to the commencement of high-speed transmission in the opposite direction. The transmitting device may disable or otherwise modify the operation of its high-speed drivers after sending a TAC 1016, 1026 or a Post sequence 1030, while the receiving device may enable or otherwise modify the operation of its high-speed drivers after receiving a TAC 1016, 1026 or a Post sequence 1030. Both the Post sequence 1030 and the TAC 1016, 1026 can be repeatedly transmitted. Repeating the TAC 1016 or 1026 enables a receiving device to generate a sufficient number of clock pulses to empty its data pipeline.

In one example, a first device that is configured to operate as a transmitter may stop driving the three signal wires after transmitting the TAC 1016, and during the corresponding TGAP 1018 may reconfigure its PHY to operate as a receiver. A second device that is configured to operate as a receiver may reconfigure its PHY to operate as a transmitter after detecting the TAC 1016 and the TGAP 1018. The second device may then drive the Preamble 1020 and Sync pattern 1022 to synchronize the first and second devices.

In some implementations, the duration of the TAC 1016, 1026 is similar to the duration of the Post sequence 1030. The number of repetitions of the TAC 1016, 1026 may be configured within a predefined or preconfigured range. For example, a designer may configure transmitter to operate with between 0 and k repetitions of the TAC 1016, 1026 (or the Post sequence 1030) based on operating conditions, packet sizes transmitted and so on. The duration of the TGAP 1018, 1028 may be configured to provide sufficient time to prevent driver overlap. The duration allocated or configured for TGAP 1018, 1028 may be determined based on application-specific conditions, driver turnoff characteristics, device technology, voltage and/or current driver performance characteristics and other parameters. In some examples, a “Break before Make” approach is adopted, where the line drivers of the first device (initial transmitter) are expected to enter a high impedance state before the line drivers of the second device (new transmitter) exit high impedance state. Certain driver types may be operable with some overlap when line drivers of both devices are active.

The second timing diagram 1050 of FIG. 10 illustrates bus turnaround in relation to a C-PHY ALP mode. In this example, line turnaround is signaled in a sequence 1058a, 1058b, 1058c. Each sequence 1058a, 1058b, 1058c includes a TAC 1062 transmitted between a Post1 1060 and a Post2 1064.

### Packet-Based Mode Control in C-PHY

Certain aspects disclosed herein, relate to a turnaround procedure for C-PHY interfaces that can be performed by transmitting a turnaround packet, sub-packet or sequence that enables turnaround without entering low-power mode of communication. In some instances, each turnaround time can be reduced by approximately 1 microsecond.

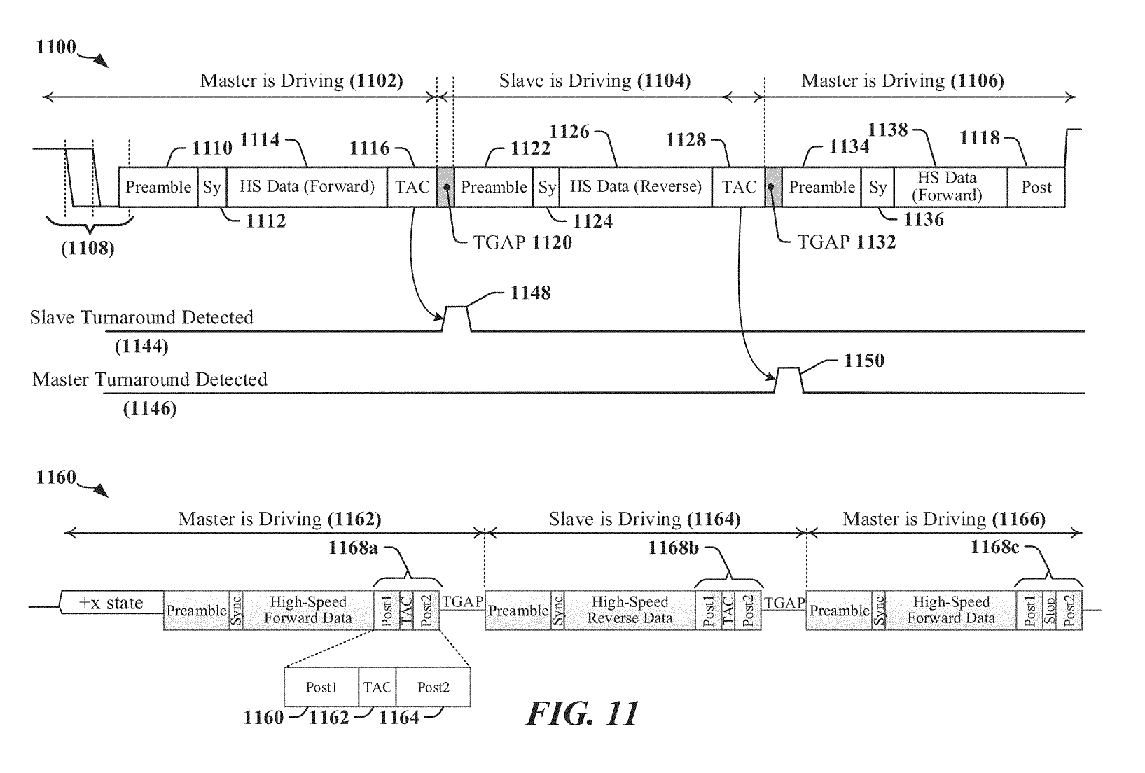

FIG. 11 illustrates an example of a turnaround procedure for a C-PHY interface. A TAC 1116, 1128 may be transmitted in high-speed mode to signal a turn-around event. According to certain aspects, the TAC 1116, 1128 may be transmitted to signal the receiver to stop reception and to change the direction of transmission. As illustrated in the first timing diagram 1100 of FIG. 11, a high-speed burst begins after transmission of a SoT sequence 1108 that may include LP codes {LP-111, LP-001, LP-000}. In high-speed communication mode, transmission begins with a Preamble 1110 and a Sync pattern 1112, followed by the High-Speed Forward Data 1114 (as discussed, for example, in relation to FIG. 10). At the end of the High-Speed Forward Data 1114 the master device sends a TAC 1116 to signal a change in direction, before commencing a turnaround gap (TGAP) 1120 by driving the physical interface to a fixed state, for example. In the TGAP 1120, the master device begins to disable its high-speed drivers. The slave device, having detected the TAC 1116 and generated a pulse 1148 on a control signal 1144, begins driving the TGAP 1120 on the physical interface. After a delay, the slave device begins to transmit the Preamble 1122 followed by the Sync pattern 1124 to synchronize the receiver in the master device. After the slave device has transmitted the Sync pattern 1124, it may send High-Speed Reverse Data 1126 to the master device. At the end of the High-Speed Reverse Data 1126 the slave device sends a TAC 1128 to signal a change in direction before commencing a TGAP 1132. In the TGAP 1132, the slave device begins to disable its High-Speed drivers. The master device detects the TAC 1128 and may generate a pulse 1150 in a control signal 1146. The change from reverse direction to forward direction is then completed when the master device drives the interface during the TGAP 1132.

In the TGAP 1120, 1132, a first device that is initially configured to operate as a transmitter may stop driving the signal wires of the interface after transmitting the TAC 1116, 1128, and during the corresponding TGAP 1120, 1132, may reconfigure its PHY to operate as a receiver. A second device that is initially configured to operate as a receiver may reconfigure its PHY to operate as a transmitter after detecting the TAC 1116, 1128 and the subsequent TGAP 1120, 1132.

The duration of the TGAP 1120, 1132 may be configured to provide sufficient time to prevent driver overlap. The duration allocated or configured for TGAP 1120, 1132 may be determined based on application-specific conditions, driver turnoff characteristics, device technology, voltage and/or current driver performance characteristics and other parameters. In some examples, a “Break before Make” approach is adopted, where the line drivers of the first device (initial transmitter) are expected to enter a high impedance state before the line drivers of the second device (new transmitter) exit high impedance state. Certain driver types may be operable with some overlap when line drivers of both devices are active. When high-speed mode is to be terminated, the master device may transmit a Post sequence 1118.

The second timing diagram 1160 of FIG. 11 illustrates bus turnaround in relation to a C-PHY ALP mode. In this example, line turnaround is signaled in a sequence 1168a, 1168b, 1168c. Each sequence 1168a, 1168b, 1168c includes a TAC 1162 transmitted between a Post 1 1160 and a Post2 1164.

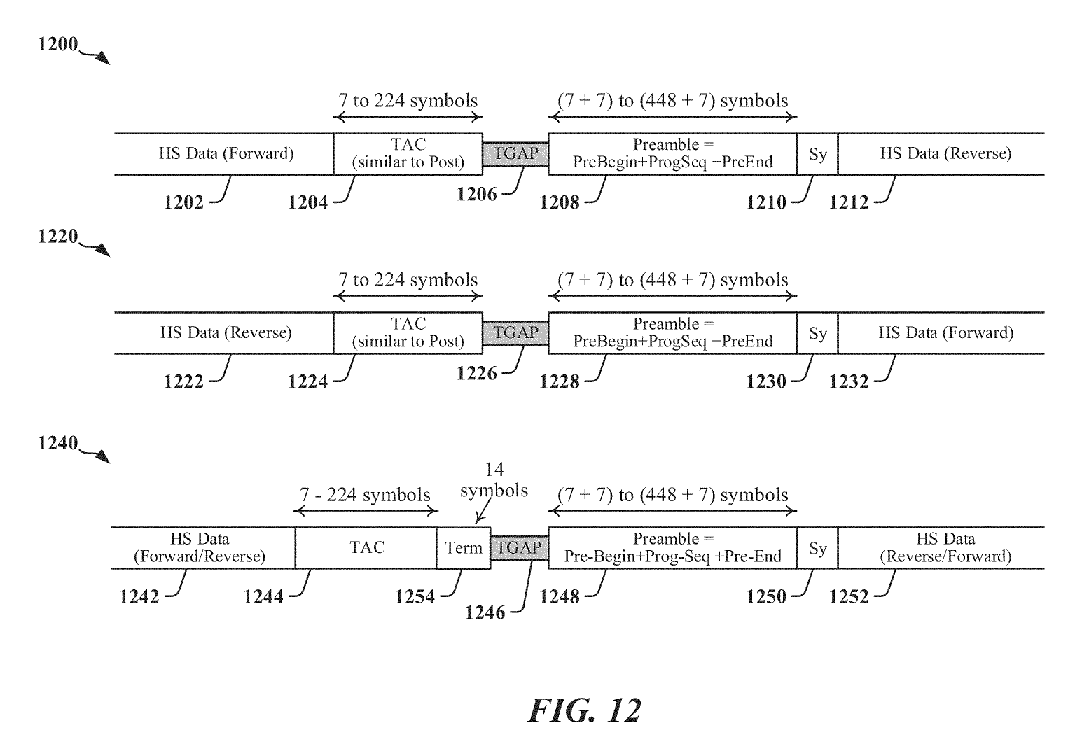

FIG. 12 illustrates certain aspects related to the use of the TAC in a C-PHY interface. A first timing diagram 1200 illustrates certain aspects related to the turnaround illustrated in FIG. 11 from forward mode transmission by the master to reverse mode transmission by a slave. After transmitting forward data 1202, a TAC 1204 is transmitted. The length of the TAC 1204 typically has a length that is similar to the length of a Post sequence 1118 that may otherwise be transmitted. In addition to the function performed by the Post sequence 1118, the TAC 1204 indicates that a turnaround event is to occur. The length of the TAC 1204 may be variable. The TAC 1204 may have a repetition length that is programmable within a range (as with the Post sequence 1118).

After transmitting the TAC 1204, the link enters a TGAP period 1206, which may be provided to avoid driver overlap. In one example, the TGAP period 1206 may extend for approximately 14 symbols (2 data words). The change of active driver operates in a break-before-make mode, where the active driver in the master enters high impedance mode before the driver in the slave enters active mode. Drivers and receivers change directions during the TGAP period 1206.

The slave then transmits the Preamble 1208 and Sync 1210. The Preamble 1208 may include a Pre-Begin that can range between 7 and 448 symbols, a Programmable sequence (optional), and a Pre-End that is 7 symbols in length. The slave may then transmit high speed data 1212.

A second timing diagram 1220 illustrates certain aspects related to the turnaround illustrated in FIG. 11 from reverse mode transmission by the slave to forward mode transmission by the master. After transmitting reverse data 1222, a TAC 1224 is transmitted. The length of the TAC 1224 typically has a length that is similar to the length of a Post sequence 1118 that may otherwise be transmitted. In addition to the function performed by the Post sequence 1118, the TAC 1224 indicates that a turnaround event is to occur. The length of the TAC 1224 may be variable. The TAC 1224 may have a repetition length that is programmable within a range.

After transmitting the TAC 1224, the link enters a TGAP period 1226, which may be provided to avoid driver overlap. In one example, the TGAP period 1226 may extend for approximately 14 symbols (2 data words). The change of active driver operates in a break-before-make mode, where the active driver in the slave enters high impedance mode before the driver in the master enters active mode. Drivers and receivers change directions during the TGAP period 1226.

The master then transmits the Preamble 1228 and Sync 1230. The Preamble 1228 may include a Pre-Begin that can range between 7 and 448 symbols, a Programmable sequence (optional), and a Pre-End that is 7 symbols in length. The master may then transmit high speed data 1232.

As noted in the first timing diagram 1200 and the second timing diagram 1220, the duration of the TAC 1204, 1224 can vary. A receiving device may be unable to determine precisely when the TGAP period 1206, 1226 begins, which can result in unexpected driver overlap in some implementations. According to certain aspects, the active driver may explicitly indicate that the TAC 1204, 1224 has ended. The timing diagram 1240 illustrates one example in which a termination code (Term 1254) is transmitted after the TAC 1244. After transmitting high-speed data 1242, the TAC 1244 is transmitted. The TAC 1244 indicates that a turnaround event is to occur. The length of the TAC 1244 may vary between implementations or applications and may have a repetition length that is programmable.

The Term 1254 follows the TAC 1244 in transmission. The Term 1254 may have a length of 14 symbols (2 data words). In one example, each symbol in the Term 1254 is a 3. After transmitting the Term 1254, the link enters the TGAP period 1246, which may be provided to avoid driver overlap. The TGAP period 1206 may extend for approximately 14 symbols (2 data words).

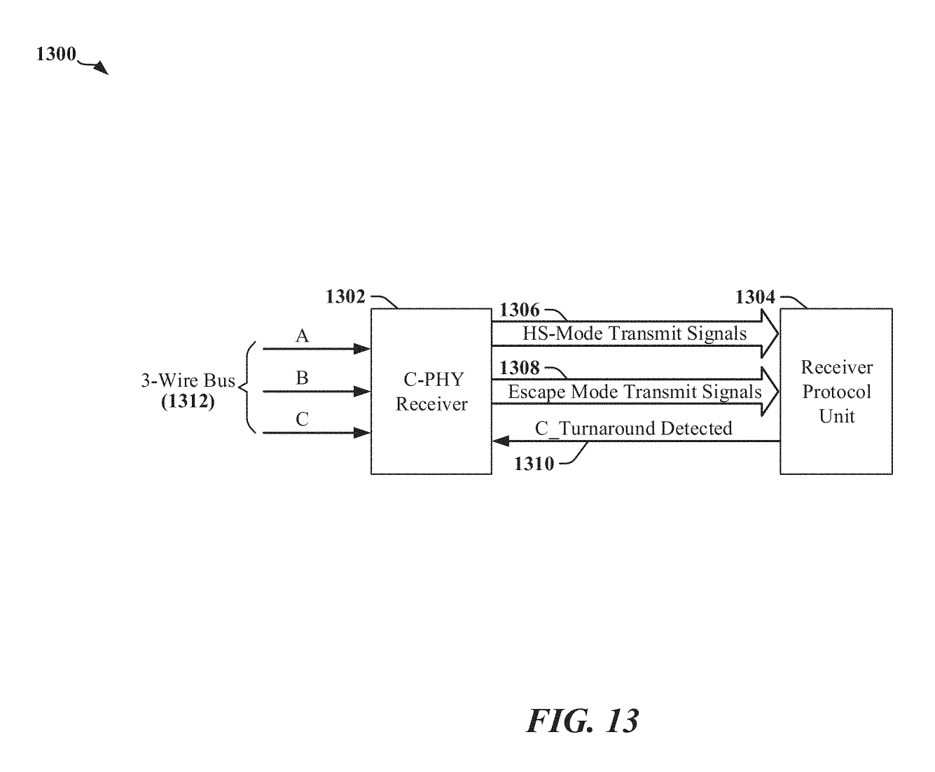

FIG. 13 illustrates a configuration of a C-PHY device 1300 showing signals provided between a C-PHY receiver 1302 and a Protocol Unit 1304. The C-PHY receiver 1302 receives data from a 3-wire bus 1312 and provides received high-speed mode signals 1306 and Escape mode signals 1308 to the Protocol Unit 1304. The Protocol Unit 1304 detects the TAC 1116, 1128 (FIG. 11) and provides a control signal (C_Turnaround_Detected 1310) to the C-PHY receiver 1302 indicating that a change of direction of transmission is requested.

### ALP ULPS Transitions in a C-PHY Interface

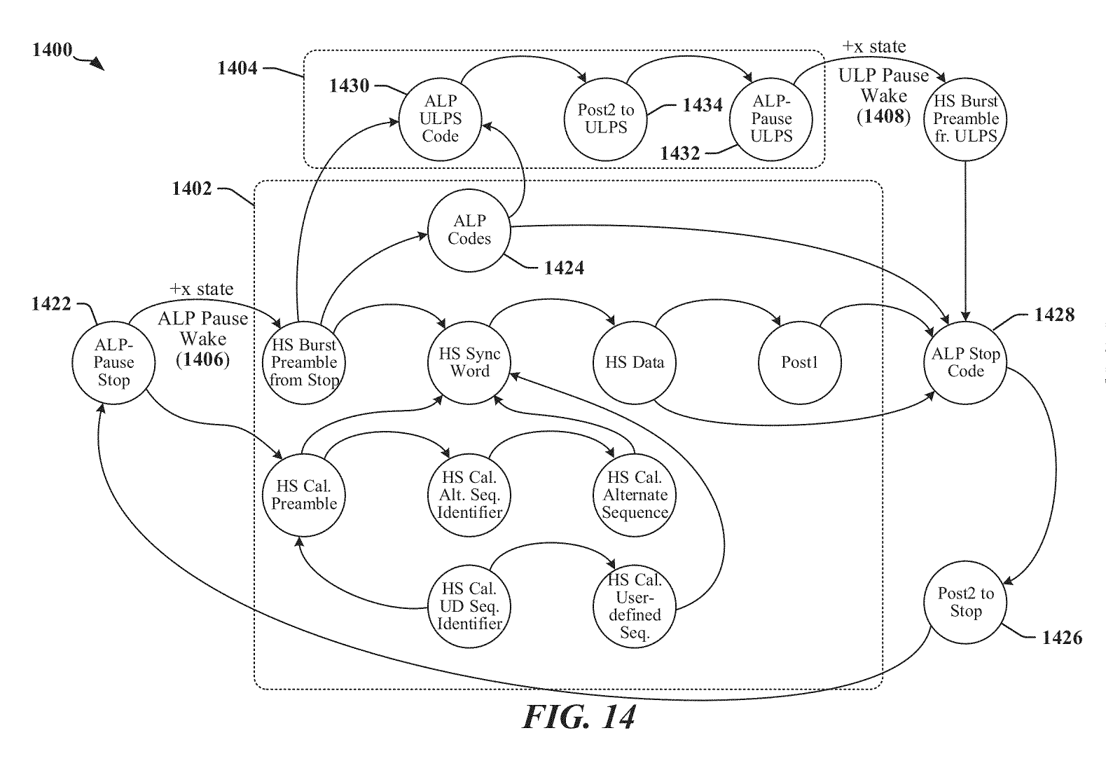

A state machine provided in a C-PHY interface may manage transitions between modes of operation. FIG. 14 is a state diagram 1400 illustrating an example of lane operation in a C-PHY interface that includes High-Speed mode 1402 and ALP Mode 1404. During normal operation in ALP Mode 1404, a lane of a C-PHY interface may be in ALP-Pause/Stop state 1422, ALP-Pause_Wake 1406. High-Speed data transmission begins and ends with an ALP-Pause/Stop state 1422. The lane is in High-Speed mode 1402 during data bursts and during ALP signaling 1424. The sequence to enter High-Speed mode 1402 for data bursts or ALP signaling may include ALP-Pause Wake 1406 followed by a preamble consisting of all 1 's or all 3's symbols. Code words can be sent after the preamble to define the specific purpose of the burst. Codes used for ALP signaling may initiate or perform identical functions as corresponding LLP Mode LP pulse sequences. The lane exits the High-Speed mode 1402 and returns to ALP-Pause/Stop state 1422 after detection of a Post2 code 1426. The Post2 code 1426 may be transmitted after a Stop Code 1428 or the ULPS Code 1430. The ALP-Pause/Stop state 1422 serves as a general standby state and may last for any period of time.

A C-PHY lane may be initially in the ALP-Pause/Stop state 1422 or the ALP-Pause ULPS state 1432 where all three Lines of the Lane are driven to the same level (e.g., V_{A}=V_{B}=V_{C}). In operation, the ALP-Pause/Stop state 1422 and the ALP-Pause ULPS state 1432 may be similar to the Legacy Low Power (LLP) Mode Stop and ULPS states, respectively. The transmitter may drive the +x state or one of the other high-speed states for an extended period of time to wake up the receiver. The transmitter then transmits a preamble. The preamble may include an all-3 symbol sequence (i.e., every symbol in the sequence has a value of ‘3’) in a data burst or an ALP command burst. The preamble may include an all-1 symbol sequence (i.e., every symbol in the sequence has a value of ‘1’) in a calibration burst. At the end of any burst the transmitter sends the Stop Code 1428 or the ULPS Code 1430. The Stop Code 1428 or the ULPS Code 1430 may inform the receiver that the link will shut down following the Post2 code 1426, 1434. The Stop Code 1428 may be followed by sequence that includes the Post2 code 1426 to inform the receiver that the link will immediately return to the ALP-Pause/Stop state. The ULPS Code 1430 may be followed by the Post2 code 1434 to inform the receiver that the link will immediately return to the ALP-Pause ULPS state 1432.

A PHY protocol may provide the receiver a longer time to wake up from the ALP-Pause ULPS state 1432 than from the ALP-Pause/Stop state. This longer time to wake up can enable the receiver to have a lower power consumption in the ALP-Pause ULPS state 1432 compared to the ALP-Pause/Stop state 1422.

According to certain aspects disclosed herein, the state machine may be adapted to manage bus turnaround in accordance with certain aspects disclosed herein. Conventional C-PHY link turnaround protocols are intended to provide a protocol that enables an efficient change in the direction of the link, using modified signaling to cause the bus turnaround (see FIG. 12, for example). The use of modified signaling can significantly increase the complexity of state machine design when the data sequences transmitted to signal a change in direction of the link are much different than data sequences transmitted to signal other control functions related to high-speed modes. For instance, the state machine may define additional states to manage data sequences introduced to support link turnaround. Each additional state requires logic to manage transitions to and from the additional states, error detection logic to determine timeouts, link failure and other state related conditions. The additional states can cause the introduction of intermediate states to handle transitions to and from previously-defined states. In one example, a state machine configured to handle the high-speed sequence illustrated in the timing diagram 1240 of FIG. 12 requires an additional loop of states to coordinate transmission and reception of the high-speed sequence. The state machine on the receiving side needs to check for both Post 1 and TAC to detect that a burst is about to end.

### Efficient Fast Link Turnaround

Certain aspects disclosed herein enable fast turnaround of links with minimal increased complexity of the state machine controlling the link. In one aspect, link direction may be reversed using a high-speed control sequence that is similar in configuration to other Alternate Low Power (ALP) sequences, such as the ALP sequences handled by the state diagram 1400 illustrated in FIG. 14. In many instances, the high-speed state machine that coordinates transmission and reception of ALP code words can be left intact, with simple modifications implemented for switching direction of the Link.

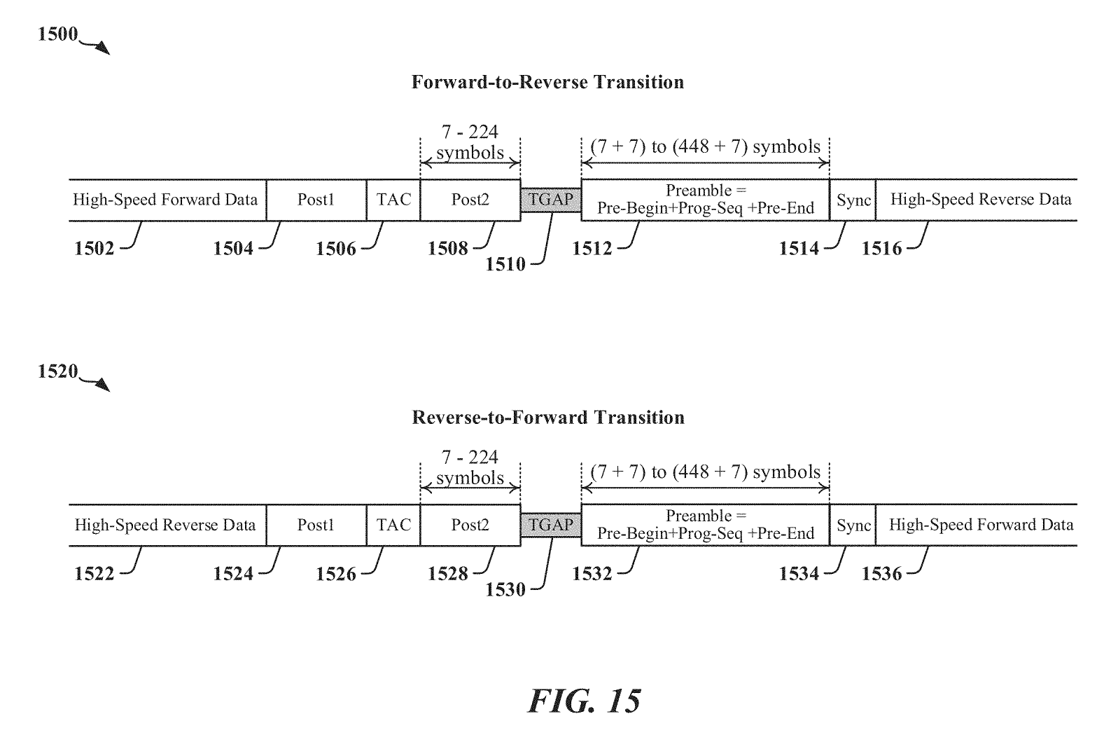

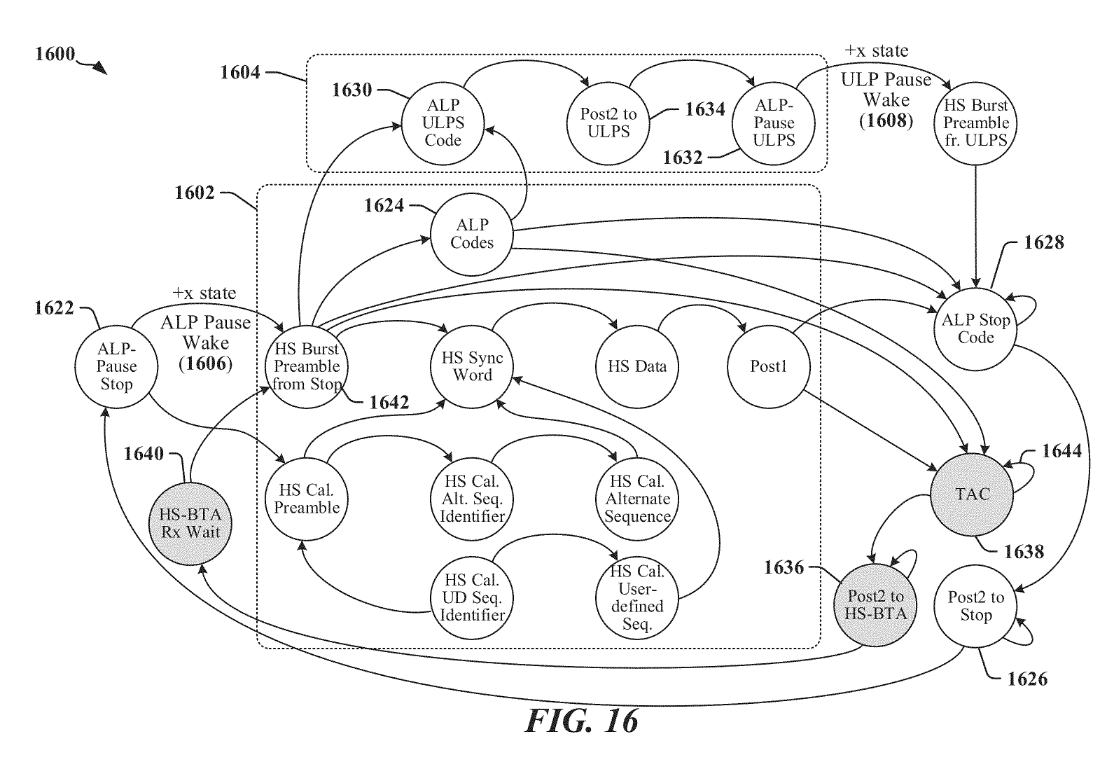

FIG. 15 illustrates an example of efficient turnaround signaling provided in accordance with certain aspects disclosed herein. The timing diagrams of FIG. 15 illustrate signaling 1500, 1520 in which link turnaround at the end of data transmission bursts 1502, 1522 is signaled by transmission of a Post 1 code 1504, 1524, one or more TAC codes 1506, 1526 and a Post2 code 1508, 1528. In some instances, multiple TAC codes 1506, 1526 are transmitted for robustness, to ensure that the receiver can detect TAC when errors affect the link. The transmission of multiple TAC codes 1506, 1526 can prevent system lock where, for example, the master attempts to hand off control to the slave, and the slave does not detect a TAC code 1506, 1526 (See the loop 1644 at state 1638 in FIG. 16). The format of this signaling closely matches the format of the end of data burst signaling transmitted in ALP mode. In the illustrated signaling 1500, 1520 a TAC code 1506, 1526 is transmitted between two Post fields, and an ALP Stop Code is transmitted between the two Post fields in an ALP-mode end of data burst signaling.

After transmitting the turnaround signaling, the link enters the TGAP period 1510, 1530, which may be provided to avoid driver overlap. In one example, the TGAP period 1510, 1530 may extend for approximately 14 symbols (2 data words). After the TGAP period 1510, 1530, the link is expected to have reversed direction and reverse direction preambles 1512, 1532 are transmitted followed by Sync 1514, 1534 before reverse direction data 1516, 1536.

FIG. 16 illustrates an example of a state diagram 1600 that is adapted in accordance with certain aspects disclosed herein. The state diagram 1600 includes modifications introduced to support the efficient fast bus turnaround signaling 1500, 1520 illustrated in FIG. 15. The state diagram 1600 may be implemented by a state machine that supports both ALP signaling and the efficient fast bus turnaround signaling 1500, 1520 disclosed herein. The differences between the state diagram 1600 and the state diagram 1400 of FIG. 14 include the addition of three states 1638, 1636, 1640. These additional states 1636, 1638, 1640 provide a path parallel to the path provided by states 1628, 1626, 1622. In some implementations, states 1628, 1626, 1622 can be merged with states 1638, 1636, 1640, with the addition of additional state information indicating whether an ALP Stop code or TAC has been received. The additional state information may be used to control decision-making by the state machine in merged states.

The turnaround event is signaled by transmission of one or more TAC codes 1506, 1526 followed by a Post2 code 1508, 1528. A TAC code 1506, 1526 is transmitted while the state machine is in the TAC state 1638. The state machine enters the Post2-to-HS_BTA state 1636, from which it transmits the Post2 code 1508, 1528. After Post2 has been transmitted, the state machine transitions to the HS-BTA_Rx_Wait state 1640 where the state machine holds until the device at the opposite end of the link finishes transmitting a turnaround sequence (Post1, TAC and Post2).

### Additional Descriptions of Certain Aspects

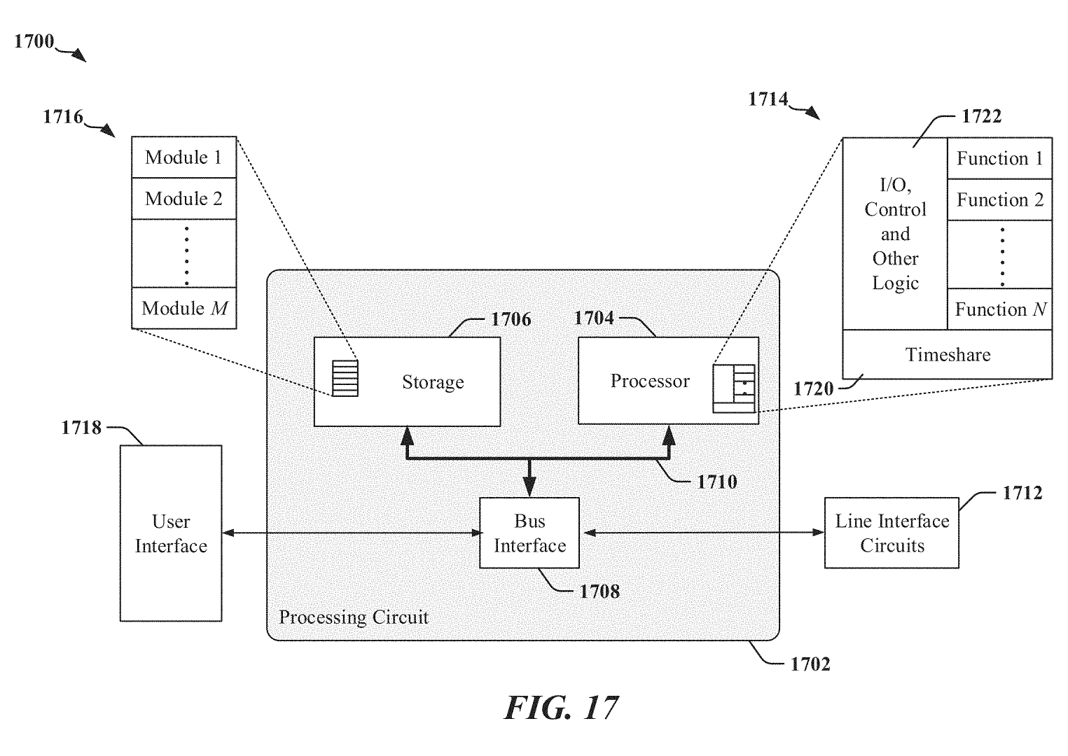

FIG. 17 is a conceptual diagram 1700 illustrating a simplified example of a hardware implementation for an apparatus employing a processing circuit 1702 that may be configured to perform one or more functions disclosed herein. In accordance with various aspects of the disclosure, an element, or any portion of an element, or any combination of elements as disclosed herein may be implemented using the processing circuit 1702. The processing circuit 1702 may include one or more processors 1704 that are controlled by some combination of hardware and software modules. Examples of processors 1704 include microprocessors, microcontrollers, digital signal processors (DSPs), ASICs field programmable gate arrays (FPGAs), programmable logic devices (PLDs), state machines, sequencers, gated logic, discrete hardware circuits, and other suitable hardware configured to perform the various functionality described throughout this disclosure. The one or more processors 1704 may include specialized processors that perform specific functions, and that may be configured, augmented or controlled by one of the software modules 1716. The one or more processors 1704 may be configured through a combination of software modules 1716 loaded during initialization, and further configured by loading or unloading one or more software modules 1716 during operation.

In the illustrated example, the processing circuit 1702 may be implemented with a bus architecture, represented generally by the bus 1710. The bus 1710 may include any number of interconnecting buses and bridges depending on the specific application of the processing circuit 1702 and the overall design constraints. The bus 1710 links together various circuits including the one or more processors 1704, and storage 1706. Storage 1706 may include memory devices and mass storage devices, and may be referred to herein as computer-readable media and/or processor-readable media. The bus 1710 may also link various other circuits such as timing sources, timers, peripherals, voltage regulators, and power management circuits. A bus interface 1708 may provide an interface between the bus 1710 and one or more line interface circuits 1712. A line interface circuit 1712 may be provided for each networking technology supported by the processing circuit. In some instances, multiple networking technologies may share some or all of the circuitry or processing modules found in a line interface circuit 1712. Each line interface circuit 1712 provides a means for communicating with various other apparatus over a transmission medium. Depending upon the nature of the apparatus, a user interface 1718 (e.g., keypad, display, speaker, microphone, joystick) may also be provided, and may be communicatively coupled to the bus 1710 directly or through the bus interface 1708.

A processor 1704 may be responsible for managing the bus 1710 and for general processing that may include the execution of software stored in a computer-readable medium that may include the storage 1706. In this respect, the processing circuit 1702, including the processor 1704, may be used to implement any of the methods, functions and techniques disclosed herein. The storage 1706 may be used for storing data that is manipulated by the processor 1704 when executing software, and the software may be configured to implement any one of the methods disclosed herein.

One or more processors 1704 in the processing circuit 1702 may execute software.

Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1706 or in an external computer readable medium. The external computer-readable medium and/or storage 1706 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium and/or storage 1706 may also include, by way of example, a carrier wave, a transmission line, and any other suitable medium for transmitting software and/or instructions that may be accessed and read by a computer. Computer-readable medium and/or the storage 1706 may reside in the processing circuit 1702, in the processor 1704, external to the processing circuit 1702, or be distributed across multiple entities including the processing circuit 1702. The computer-readable medium and/or storage 1706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1706 may maintain software maintained and/or organized in loadable code segments, modules, applications, programs, etc., which may be referred to herein as software modules 1716. Each of the software modules 1716 may include instructions and data that, when installed or loaded on the processing circuit 1702 and executed by the one or more processors 1704, contribute to a run-time image 1714 that controls the operation of the one or more processors 1704. When executed, certain instructions may cause the processing circuit 1702 to perform functions in accordance with certain methods, algorithms and processes described herein.

Some of the software modules 1716 may be loaded during initialization of the processing circuit 1702, and these software modules 1716 may configure the processing circuit 1702 to enable performance of the various functions disclosed herein. For example, some software modules 1716 may configure internal devices and/or logic circuits 1722 of the processor 1704, and may manage access to external devices such as the line interface circuit 1712, the bus interface 1708, the user interface 1718, timers, mathematical coprocessors, and so on. The software modules 1716 may include a control program and/or an operating system that interacts with interrupt handlers and device drivers, and that controls access to various resources provided by the processing circuit 1702. The resources may include memory, processing time, access to the line interface circuit 1712, the user interface 1718, and so on.

One or more processors 1704 of the processing circuit 1702 may be multifunctional, whereby some of the software modules 1716 are loaded and configured to perform different functions or different instances of the same function. The one or more processors 1704 may additionally be adapted to manage background tasks initiated in response to inputs from the user interface 1718, the line interface circuit 1712, and device drivers, for example. To support the performance of multiple functions, the one or more processors 1704 may be configured to provide a multitasking environment, whereby each of a plurality of functions is implemented as a set of tasks serviced by the one or more processors 1704 as needed or desired. In one example, the multitasking environment may be implemented using a timesharing program 1720 that passes control of a processor 1704 between different tasks, whereby each task returns control of the one or more processors 1704 to the timesharing program 1720 upon completion of any outstanding operations and/or in response to an input such as an interrupt. When a task has control of the one or more processors 1704, the processing circuit is effectively specialized for the purposes addressed by the function associated with the controlling task. The timesharing program 1720 may include an operating system, a main loop that transfers control on a round-robin basis, a function that allocates control of the one or more processors 1704 in accordance with a prioritization of the functions, and/or an interrupt driven main loop that responds to external events by providing control of the one or more processors 1704 to a handling function.

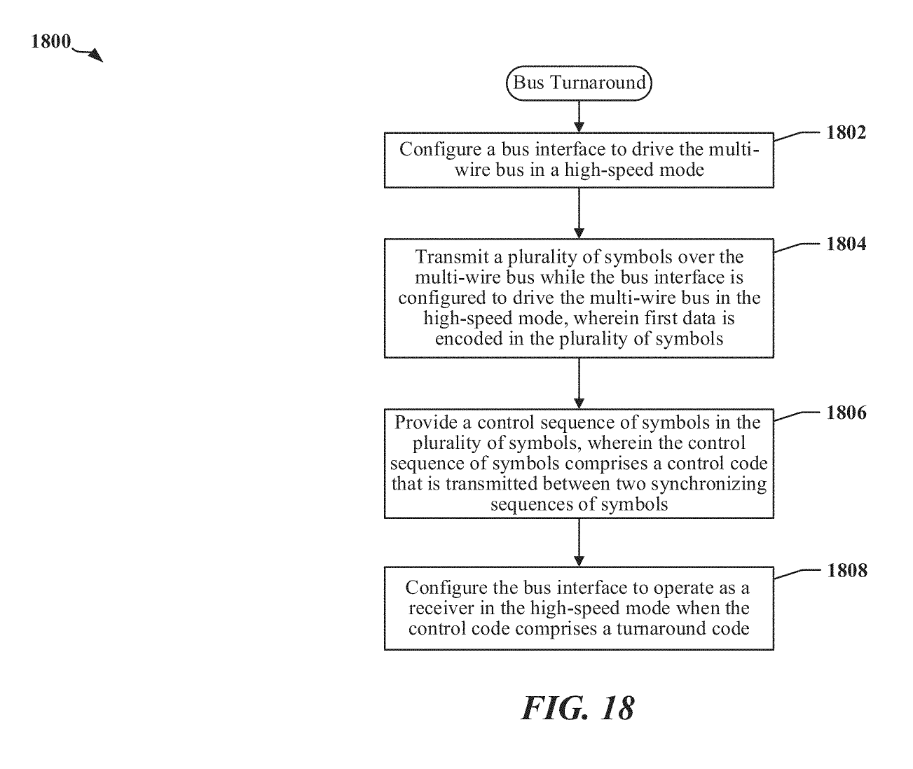

FIG. 18 is a flow chart 1800 of a method operational at a device coupled to a multi-wire bus. At block 1802, the device may configure a bus interface to drive the multi-wire bus in a high-speed mode. At block 1804, the device may transmit a plurality of symbols over the multi-wire bus while the bus interface is configured to drive the multi-wire bus in the high-speed mode. First data may be encoded in the plurality of symbols. At block 1806, the device may provide a control sequence of symbols in the plurality of symbols. The control sequence of symbols may include a control code that is transmitted between two synchronizing sequences of symbols. At block 1808, the device may configure the bus interface to operate as a receiver in the high-speed mode when the control code includes a turnaround code.

In certain implementations, the method includes encoding 16 bits of the data in a permutation of 7 symbols, and transmitting the 7 symbols as part of the plurality of symbols. Each symbol may define signaling state of three wires in a corresponding symbol transmission interval. Timing information associated with transmission of the 7 symbols may be encoded in transitions of state of the three wires between each pair of consecutive symbol transmission intervals. The 16 bits of the data in the permutation of 7 symbols may be encoded by using the 16 bits of the data to select the permutation of 7 symbols based on a mapping of 16-bit data to 7-symbol sequences. The turnaround code may include a 7-symbol sequence unused by the mapping of 16-bit data to 7-symbol sequences. 6 signaling states may be defined for the three wires, where signaling state changes between each pair of consecutive symbol transmission intervals, and where one of 5 available signaling states of the three wires for each symbol transmission interval is selected based on value of a corresponding symbol.

In one example, the method includes decoding second data from symbols received from the multi-wire bus after transmitting the turnaround code, and configuring the bus interface to drive the multi-wire bus in the high-speed mode after a second instance of the turnaround code is detected in the symbols received from the multi-wire bus.

In some examples, the method includes providing a sequence of signaling states on the multi-wire bus when the bus interface is configured to drive the multi-wire bus in a low-power mode. The sequence of signaling states may be configured to indicate a transition from low-power mode to high-speed mode. Voltage range of signaling states in the high-speed mode may be lower than voltage range of corresponding signaling states in the low-power mode. The high-speed mode may be a MIPI Alliance defined C-PHY high-speed mode. Each of the two synchronizing sequences of symbols includes a MIPI Alliance defined C-PHY Post sequence.

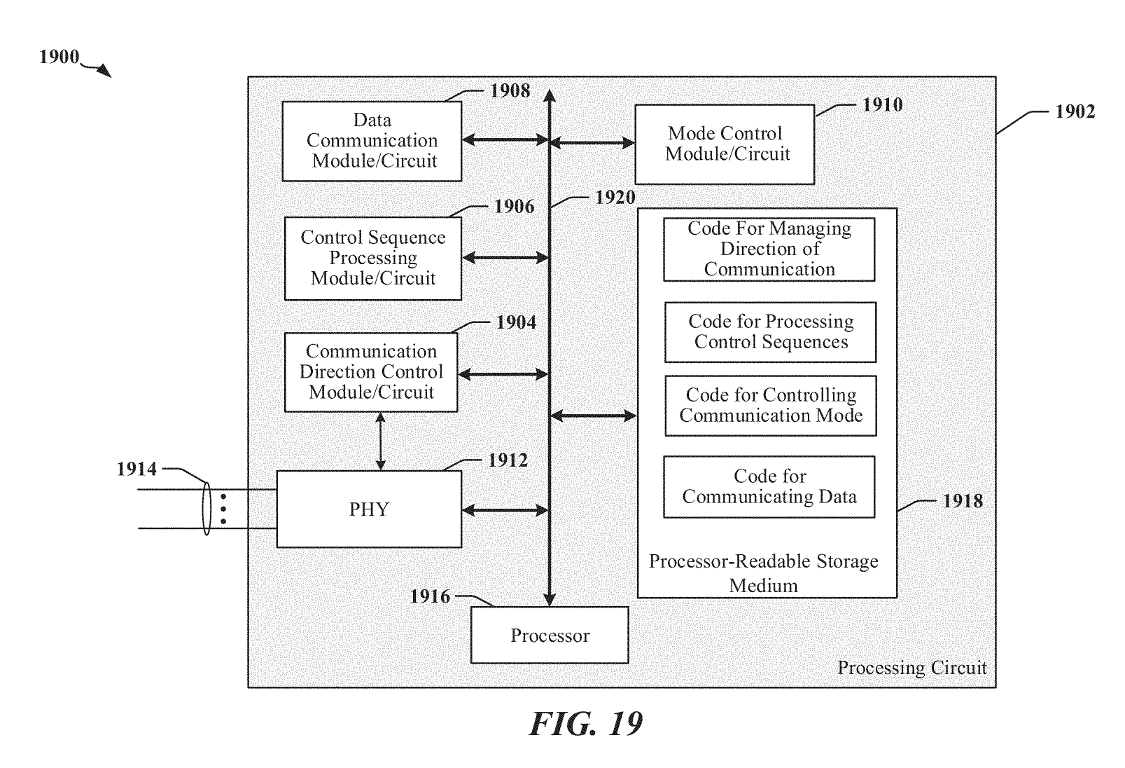

FIG. 19 is a diagram illustrating a simplified example of a hardware implementation for an apparatus 1900 employing a processing circuit 1902. The processing circuit typically has a processor 1916 that may include one or more of a microprocessor, microcontroller, digital signal processor, a sequencer and a state machine. The processing circuit 1902 may be implemented with a bus architecture, represented generally by the bus 1920. The bus 1920 may include any number of interconnecting buses and bridges depending on the specific application of the processing circuit 1902 and the overall design constraints. The bus 1920 links together various circuits including one or more processors and/or hardware modules, represented by the processor 1916, the modules or circuits 1904, 1906, 1908, and 1910, a PHY 1912 configurable to communicate over connectors or wires of a multi-wire communication link 1914 and the computer-readable storage medium 1918. The bus 1920 may also link various other circuits such as timing sources, peripherals, voltage regulators, and power management circuits.

The processor 1916 is responsible for general processing, including the execution of software stored on the computer-readable storage medium 1918. The software, when executed by the processor 1916, causes the processing circuit 1902 to perform the various functions described supra for any particular apparatus. The computer-readable storage medium 1918 may also be used for storing data that is manipulated by the processor 1916 when executing software, including data decoded from symbols transmitted over the communication link 1914, which may be configured as data lanes and clock lanes. The processing circuit 1902 further includes at least one of the modules 1904, 1906, 1908, and 1910. The modules 1904, 1906, 1908, and 1910 may be software modules running in the processor 1916, resident/stored in the computer-readable storage medium 1918, one or more hardware modules coupled to the processor 1916, or some combination thereof. The 1904, 1906, 1908, and/or 1910 may include microcontroller instructions, state machine configuration parameters, or some combination thereof.

In one configuration, the apparatus 1900 for data communication includes modules and/or circuits 1908, 1912 configured to transmit and receive data in sequences of symbols using a multi-wire communication link 1914. The apparatus may include modules and/or circuits 1904 configured to reconfigure the direction of the PHY 1912, including when operated in a high-speed mode of operation. The apparatus may include modules and/or circuits 1906, 1910 configured to insert and/or substitute control sequences of symbols into the stream of symbols transmitted on the multi-wire communication link 1914.

In one example, the apparatus 1900 may include an interface circuit 1912 configured to communicate data using a 3-phase signal transmitted in different phases on all three wires of a 3-wire communication link. The processor 1916 may include a state machine adapted to configure the bus interface to drive the multi-wire bus in a high-speed mode, cause the bus interface to transmit a plurality of symbols over the multi-wire bus while the bus interface is configured to drive the multi-wire bus in the high-speed mode. First data may be encoded in the plurality of symbols. The state machine may be further adapted to provide a control sequence of symbols in the plurality of symbols. The control sequence of symbols may include a control code that is transmitted between two synchronizing sequences of symbols. The state machine may be further adapted to configure the bus interface to operate as a receiver in the high-speed mode when the control code includes a turnaround code.

In some examples, the apparatus has an encoder configured to encode 16 bits of the first data in a permutation of 7 symbols, and transmitting the 7 symbols as part of the plurality of symbols. Each symbol may define signaling state of three wires in a corresponding symbol transmission interval. Timing information associated with transmission of the 7 symbols may be encoded in transitions of state of the three wires between each pair of consecutive symbol transmission intervals. The 16 bits of the data in the permutation of 7 symbols may be encoded by using the 16 bits of the data to select the permutation of 7 symbols based on a mapping of 16-bit data to 7-symbol sequences. The turnaround code may include a 7-symbol sequence unused by the mapping of 16-bit data to 7-symbol sequences. 6 signaling states may be defined for the three wires, where signaling state changes between each pair of consecutive symbol transmission intervals, and where one of 5 available signaling states of the three wires for each symbol transmission interval is selected based on value of a corresponding symbol.

In one example, the encoder is further configured to decode second data from symbols received from the multi-wire bus after transmitting the turnaround code, and the state machine is further adapted to configure the bus interface to drive the multi-wire bus in the high-speed mode after a second instance of the turnaround code is detected in the symbols received from the multi-wire bus.

In some examples, the state machine is further configured to cause the bus interface to provide a sequence of signaling states on the multi-wire bus when the bus interface is configured to drive the multi-wire bus in a low-power mode. The sequence of signaling states may be configured to indicate a transition from low-power mode to high-speed mode. Voltage range of signaling states in the high-speed mode may be lower than voltage range of corresponding signaling states in the low-power mode. The high-speed mode may be a MIPI Alliance defined C-PHY high-speed mode. Each of the two synchronizing sequences of symbols includes a MIPI Alliance defined C-PHY Post sequence.

In another example, the processor-readable storage medium 1918 includes, stores or maintains processor-executable code for configuring a bus interface to drive the multi-wire bus in a high-speed mode, transmitting a plurality of symbols over the multi-wire bus while the bus interface is configured to drive the multi-wire bus in the high-speed mode, providing a control sequence of symbols in the plurality of symbols, and configuring the bus interface to operate as a receiver in the high-speed mode when the control code includes a turnaround code. First data may be encoded in the plurality of symbols. The control sequence of symbols may include a control code that is transmitted between two synchronizing sequences of symbols.

In certain examples, the storage medium 1918 includes, stores or maintains processor-executable code for encoding 16 bits of the data in a permutation of 7 symbols, and transmitting the 7 symbols as part of the plurality of symbols. Each symbol may define signaling state of three wires in a corresponding symbol transmission interval. Timing information associated with transmission of the 7 symbols may be encoded in transitions of state of the three wires between each pair of consecutive symbol transmission intervals. The 16 bits of the data in the permutation of 7 symbols may be encoded by using the 16 bits of the data to select the permutation of 7 symbols based on a mapping of 16-bit data to 7-symbol sequences. The turnaround code may include a 7-symbol sequence unused by the mapping of 16-bit data to 7-symbol sequences. 6 signaling states may be defined for the three wires, where signaling state changes between each pair of consecutive symbol transmission intervals, and where one of 5 available signaling states of the three wires for each symbol transmission interval is selected based on value of a corresponding symbol.

In one aspect, the storage medium 1918 includes, stores or maintains processor-executable code for decoding second data from symbols received from the multi-wire bus after transmitting the turnaround code, and configuring the bus interface to drive the multi-wire bus in the high-speed mode after a second instance of the turnaround code is detected in the symbols received from the multi-wire bus.

In some aspects, the storage medium 1918 includes, stores or maintains processor-executable code for providing a sequence of signaling states on the multi-wire bus when the bus interface is configured to drive the multi-wire bus in a low-power mode. The sequence of signaling states may be configured to indicate a transition from low-power mode to high-speed mode. Voltage range of signaling states in the high-speed mode may be lower than voltage range of corresponding signaling states in the low-power mode. The high-speed mode may be a MIPI Alliance defined C-PHY high-speed mode. Each of the two synchronizing sequences of symbols includes a MIPI Alliance defined C-PHY Post sequence.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method performed in a device coupled to a multi-wire bus, comprising:
configuring a bus interface to drive the multi-wire bus in a high-speed mode;
transmitting a plurality of symbols over the multi-wire bus while the bus interface is configured to drive the multi-wire bus in the high-speed mode, wherein first data is encoded in the plurality of symbols;
providing a control sequence of symbols in the plurality of symbols, wherein the control sequence of symbols comprises a control code that is transmitted between two synchronizing sequences of symbols; and
configuring the bus interface to operate as a receiver in the high-speed mode when the control code comprises a turnaround code.

2. The method of claim 1, further comprising:
encoding 16 bits of the first data in a permutation of 7 symbols; and
transmitting the permutation of 7 symbols as part of the plurality of symbols,
wherein each symbol defines signaling state of three wires in a corresponding symbol transmission interval.

3. The method of claim 2, wherein timing information associated with transmission of the permutation of 7 symbols is encoded in transitions of state of the three wires between each pair of consecutive symbol transmission intervals.

4. The method of claim 2, wherein encoding the 16 bits of the first data in the permutation of 7 symbols comprises:
using the 16 bits of the first data to select the permutation of 7 symbols based on a mapping of 16-bit data to 7-symbol sequences, and
wherein the turnaround code comprises a 7-symbol sequence unused by the mapping of 16-bit data to 7-symbol sequences.

5. The method of claim 2, wherein 6 signaling states are defined for the three wires, wherein signaling state changes between each pair of consecutive symbol transmission intervals, and wherein one of 5 available signaling states of the three wires for each symbol transmission interval is selected based on value of a corresponding symbol.

6. The method of claim 1, further comprising:
decoding second data from symbols received from the multi-wire bus after transmitting the turnaround code; and
configuring the bus interface to drive the multi-wire bus in the high-speed mode after a second instance of the turnaround code is detected in the symbols received from the multi-wire bus.

7. The method of claim 1, further comprising:
providing a sequence of signaling states on the multi-wire bus when the bus interface is configured to drive the multi-wire bus in a low-power mode,
wherein the sequence of signaling states is configured to indicate a transition from low-power mode to high-speed mode.

8. The method of claim 7, wherein a voltage range of signaling states in the high-speed mode is lower than a voltage range of corresponding signaling states in the low-power mode.

9. The method of claim 1, wherein the high-speed mode comprises a Mobile Industry Processor Interface (MIPI) Alliance defined C-PHY high-speed mode.

10. The method of claim 1, wherein each of the two synchronizing sequences of symbols comprises a MIPI Alliance defined C-PHY Post sequence.

11. An apparatus comprising:
a bus interface coupled to a multi-wire bus; and
a state machine configured to:
configure the bus interface to drive the multi-wire bus in a high-speed mode;
cause the bus interface to transmit a plurality of symbols over the multi-wire bus while the bus interface is configured to drive the multi-wire bus in the high-speed mode, wherein first data is encoded in the plurality of symbols;
provide a control sequence of symbols in the plurality of symbols, wherein the control sequence of symbols comprises a control code that is transmitted between two synchronizing sequences of symbols; and
configure the bus interface to operate as a receiver in the high-speed mode when the control code comprises a turnaround code.

12. The apparatus of claim 11, further comprising:
an encoder configured to encode 16 bits of the first data in a permutation of 7 symbols,
wherein the state machine is further configured to transmit the permutation of 7 symbols as part of the plurality of symbols, and
wherein each symbol in the plurality of symbols defines signaling state of three wires in a corresponding symbol transmission interval.

13. The apparatus of claim 12, wherein timing information associated with transmission of the permutation of 7 symbols is encoded in transitions of state of the three wires between each pair of consecutive symbol transmission intervals.

14. The apparatus of claim 12, wherein the encoder is further configured to:
use the 16 bits of the first data to select the permutation of 7 symbols based on a mapping of 16-bit data to 7-symbol sequences, and
wherein the turnaround code comprises a 7-symbol sequence unused by the mapping of 16-bit data to 7-symbol sequences.

15. The apparatus of claim 12, wherein 6 signaling states are defined for the three wires, wherein signaling state changes between each pair of consecutive symbol transmission intervals, and wherein one of 5 available signaling states of the three wires for each symbol transmission interval is selected based on value of a corresponding symbol.

16. The apparatus of claim 12, wherein the encoder is further configured to:
decode second data from symbols received from the multi-wire bus after transmitting the turnaround code, and wherein the state machine is further configured to configure the bus interface to drive the multi-wire bus in the high-speed mode after a second instance of the turnaround code is detected in the symbols received from the multi-wire bus.

17. The apparatus of claim 11, wherein the state machine is further configured to:
cause the bus interface to provide a sequence of signaling states on the multi-wire bus when the bus interface is configured to drive the multi-wire bus in a low-power mode, and
wherein the sequence of signaling states is configured to indicate a transition from low-power mode to high-speed mode.

18. The apparatus of claim 17, wherein a voltage range of signaling states in the high-speed mode is lower than a voltage range of corresponding signaling states in the low-power mode.

19. The apparatus of claim 11, wherein the high-speed mode comprises a Mobile Industry Processor Interface (MIPI) Alliance defined C-PHY high-speed mode.

20. The apparatus of claim 11, wherein each of the two synchronizing sequences of symbols comprises a MIPI Alliance defined C-PHY Post sequence.

21. A processor-readable storage medium comprising code for:
configuring a bus interface to drive a multi-wire bus in a high-speed mode;
transmitting a plurality of symbols over the multi-wire bus while the bus interface is configured to drive the multi-wire bus in the high-speed mode, wherein first data is encoded in the plurality of symbols;
providing a control sequence of symbols in the plurality of symbols, wherein the control sequence of symbols comprises a control code that is transmitted between two synchronizing sequences of symbols; and
configuring the bus interface to operate as a receiver in the high-speed mode when the control code comprises a turnaround code.

22. The storage medium of claim 21, further comprising code for:
encoding 16 bits of the first data in a permutation of 7 symbols; and
transmitting the permutation of 7 symbols as part of the plurality of symbols,
wherein each symbol defines signaling state of three wires in a corresponding symbol transmission interval.

23. The storage medium of claim 22, wherein timing information associated with transmission of the permutation of 7 symbols is encoded in transitions of state of the three wires between each pair of consecutive symbol transmission intervals.

24. The storage medium of claim 22, further comprising code for:
using the 16 bits of the first data to select the permutation of 7 symbols based on a mapping of 16-bit data to 7-symbol sequences,
wherein the turnaround code comprises a 7-symbol sequence unused by the mapping of 16-bit data to 7-symbol sequences.

25. The storage medium of claim 22, wherein 6 signaling states are defined for the three wires, wherein signaling state changes between each pair of consecutive symbol transmission intervals, and wherein one of 5 available signaling states of the three wires for each symbol transmission interval is selected based on value of a corresponding symbol.

26. The storage medium of claim 21, further comprising code for:
decoding second data from symbols received from the multi-wire bus after transmitting the turnaround code; and
configuring the bus interface to drive the multi-wire bus in the high-speed mode after a second instance of the turnaround code is detected in the symbols received from the multi-wire bus.

27. The storage medium of claim 21, further comprising code for:
providing a sequence of signaling states on the multi-wire bus when the bus interface is configured to drive the multi-wire bus in a low-power mode,
wherein the sequence of signaling states is configured to indicate a transition from low-power mode to high-speed mode.

28. The storage medium of claim 27, wherein a voltage range of signaling states in the high-speed mode is lower than a voltage range of corresponding signaling states in the low-power mode.

29. The storage medium of claim 21, wherein the high-speed mode comprises a Mobile Industry Processor Interface (MIPI) Alliance defined C-PHY high-speed mode.

30. The storage medium of claim 21, wherein each of the two synchronizing sequences of symbols comprises a MIPI Alliance defined C-PHY Post sequence.
